(19) United States
(12) Patent Application Publication
(10) Pub. No.: US 2022/0291647 A1
(43) Pub. Date: Sep. 15, 2022

(54) ELECTRONIC CONTROL SYSTEM, ELECTRONIC-CONTROL-SYSTEM TESTING APPARATUS, AND ELECTRONIC-CONTROL-SYSTEM TESTING METHOD

(71) Applicant: Mitsubishi Electric Corporation, Tokyo (JP)

(72) Inventor: Kentaro ISHIHARA, Tokyo (JP)

(73) Assignee: Mitsubishi Electric Corporation, Tokyo (JP)

(21) Appl. No.: 17/393,501

(22) Filed: Aug. 4, 2021

(30) Foreign Application Priority Data
Mar. 12, 2021 (JP) 2021-039874

(51) Int. Cl. G05B 15/02

(52) U.S. Cl. CPC G05B 15/02; H04L 67/125

(57) ABSTRACT

Respective processing hierarchies of a control program of an electronic control system and a testing program of a testing apparatus are each configured in the same manner; requesting data for each of processing hierarchies of the control program to be executed by the electronic control system is created without making any change in a required communication specification between a transmission direction and a reception direction; requesting data for each of processing hierarchies of the testing program to be executed by the testing apparatus is created while changing a transmission direction of communication requesting data to a reception direction thereof and changing the reception direction to the transmission direction.

### BACKGROUND OF THE INVENTION

### Field of the Invention

The present disclosure relates to an electronic control system, an electronic-control-system testing apparatus, and an electronic-control-system testing method.

### Description of the Related Art

In a vehicle such as an automobile, an ECU is utilized in order to perform control processing items such as motor driving and illumination-driving of a light source or in order to perform processing control for perceiving surrounding circumstances in driving assistance, automatic driving, and the like. In this description, an ECU is a generic name signifying an Electronic Control Unit.

To date, as a means for testing expected behavior of an ECU, there has been utilized a method in which a testing apparatus is connected with a communication line of the ECU and it is confirmed by communicating with the ECU that communication with the ECU is performed according to a request.

In recent years, the kinds of and the number of data pieces to be transmitted or received by an ECU through a communication line have been increasing; therefore, even when it is tried to manually confirm that communication with the ECU is performed according to a request, the confirmation is often not completed within an allowable time. Accordingly, there is utilized a method in which a program (hereinafter, referred to as a testing program) for automatically executing a test is integrated in a testing apparatus and then it is sequentially tested whether or not each of data pieces to be transmitted or received by an ECU is correctly transmitted or received.

In automating such a testing, it is also difficult to manually create a testing apparatus for ascertaining communication data pieces that are so large in number to make it difficult to manually ascertain; therefore, it is required that a program to be executed by the testing apparatus is created automatically as much as possible.

A communication request of an ECU is often made into a data base; at least a frame name, a frame identification number (hereinafter, referred to as a “frame ID”), a communication channel in which a frame is transmitted or received, the data length of a transmission/reception frame, a timing (period) of transmission/reception of a frame, respective positions and lengths (bits) of various kinds of one or more data pieces to be arranged in a frame data (byte sequence), and the like are determined for each frame.

In many cases, control software to be executed by an ECU is developed by utilizing past design; however, because there exist various kinds of communication requests and an up-to-date specification is utilized each time an ECU is developed, no communication request of a past ECU is often reused.

Accordingly, in almost all cases, the part corresponding to a communication request is all replaced each time an ECU is developed; the same applies to a testing program.

As an example of a prior art in which an automatic testing program is integrated in an ECU testing apparatus and the number of man-hours is reduced when a test is automatically performed, a technology for creating data, a test case, and the like is disclosed, for example, in any of Patent Documents 1 and 2.

### PRIOR ART REFERENCE

### Patent Literature

[Patent Document 1] Japanese Patent Application Laid-Open No. 2011-204069
[Patent Document 2] Japanese Patent Application Laid-Open No. 2015-204065

### SUMMARY OF THE INVENTION

Each of foregoing Patent Documents 1 and 2 is to efficiently create a test case that satisfies testing data and a coverage, based on a specifications of communication, a specification of software, and the like; however, because the testing data is created without considering reduction of the number of man-hours for producing a testing apparatus and the number of man-hours for creating testing processing, there has been a problem that creation of an automatic testing program and production of a testing apparatus for executing the automatic testing program should manually be performed.

The present application is to disclose a technology for solving the foregoing problem; an objective thereof is to provide an electronic control system that realizes shortening of the production time for a testing apparatus.

Moreover, an objective of the present application is to provide a testing apparatus for the electronic control system that realizes shortening of the production time for the testing apparatus.

Furthermore, an objective of the present application is to provide an electronic-control-system testing method that realizes shortening of the production time for the testing apparatus.

An electronic control system disclosed in the present disclosure includes

at least one CPU that executes a control program including at least one processing hierarchy,

a secondary storage device that stores the control program, and

a RAM configured in such a way as to be capable of storing and reading data for the control program; when behavior of the electronic control system is tested by communicating with a testing apparatus that creates requesting data for communication corresponding to processing in a testing program to be executed, while changing a transmission direction of the communication to a reception direction thereof and changing the reception direction of the communication to the transmission direction thereof, requesting data for the communication corresponding to processing in the control program to be executed is created without being changed between the transmission direction and the reception direction of the communication.

Moreover, an electronic-control-system testing apparatus disclosed in the present disclosure includes

at least one CPU that executes a testing program including at least one processing hierarchy,

a secondary storage device that stores the testing program, and

a RAM configured in such a way as to be capable of storing and reading data for the testing program; when behavior of an electronic control system is tested by communicating with the electronic control system that creates requesting data for communication corresponding to processing in a control program to be executed, without making any change between a transmission direction of the communication and a reception direction thereof, requesting data for the communication corresponding to processing in the testing program to be executed is created, while changing the transmission direction of the communication to the reception direction thereof and changing the reception direction of the communication to the transmission direction thereof.

Furthermore, in an electronic-control-system testing method disclosed in the present disclosure, behavior of an electronic control system is tested based on communication between the electronic control system and the testing apparatus; the electronic control system includes

at least one CPU that executes a control program including at least one processing hierarchy,

a secondary storage device that stores the control program, and

a RAM configured in such a way as to be capable of storing and reading data for the control program; the testing apparatus includes

at least one CPU that executes a testing program including at least one processing hierarchy,

a secondary storage device that stores the testing program, and

a RAM configured in such a way as to be capable of storing and reading data for the testing program; requesting data for the communication corresponding to processing in the control program to be executed is created without being changed between a transmission direction and a reception direction of the communication; requesting data for the communication corresponding to processing in the testing program to be executed is created, while changing the transmission direction of the communication to the reception direction thereof and changing the reception direction of the communication to the transmission direction thereof.

The present disclosure makes it possible to obtain an electronic control system that realizes shortening of the production time for a testing apparatus.

Moreover, the present disclosure makes it possible to obtain an electronic-control-system testing apparatus that realizes shortening of the production time for a testing apparatus.

Furthermore, the present disclosure makes it possible to obtain an electronic-control-system testing method that realizes shortening of the production time for a testing apparatus.

Moreover, the present disclosure makes it possible to obtain a testing apparatus and a testing method that realize shortening of the production time for a testing apparatus.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a configuration diagram representing an electronic control system and a testing apparatus according to Embodiment 1;

FIG. 2 is an explanatory diagram exemplarily representing respective contents of variables to be accessed by a communication part of a control program in the electronic control system according to Embodiment 1;

FIG. 3 is an explanatory diagram exemplarily representing the contents of a communication part of the control program in the electronic control system according to Embodiment 1;

FIG. 4 is an explanatory diagram exemplarily representing main hardware abstraction data pieces to which with regard to communication, hardware abstraction processing refers in the electronic control system according to Embodiment 1;

FIG. 5 is a flowchart exemplarily representing a procedure of communication-related initialization processing in the hardware abstraction processing in the electronic control system according to Embodiment 1;

FIG. 6 is a flowchart exemplarily representing a procedure of frame reception processing in the hardware abstraction processing in the electronic control system according to Embodiment 1;

FIG. 7 is a flowchart exemplarily representing a procedure of frame transmission processing in the hardware abstraction processing in the electronic control system according to Embodiment 1;

FIG. 8 is a flowchart exemplarily representing a procedure of frame transmission completion processing in the hardware abstraction processing in the electronic control system according to Embodiment 1;

FIG. 9 is a flowchart exemplarily representing a procedure of periodic processing in the hardware abstraction processing in the electronic control system according to Embodiment 1;

FIG. 10 is an explanatory diagram exemplarily representing main communication channel abstraction data pieces to which channel abstraction processing refers in the electronic control system according to Embodiment 1;

FIG. 11 is a flowchart exemplarily representing a procedure of initialization processing in the channel abstraction processing in the electronic control system according to Embodiment 1;

FIG. 12 is a flowchart exemplarily representing a procedure of frame reception processing in the channel abstraction processing in the electronic control system according to Embodiment 1;

FIG. 13 is a flowchart exemplarily representing a procedure of frame transmission processing in the channel abstraction processing in the electronic control system according to Embodiment 1;

FIG. 14 is a flowchart exemplarily representing a procedure of frame transmission completion processing in the channel abstraction processing in the electronic control system according to Embodiment 1;

FIG. 15 is a flowchart exemplarily representing a procedure of periodic processing in the channel abstraction processing in the electronic control system according to Embodiment 1;

FIG. 16 is a flowchart exemplarily representing a procedure of frame reception monitoring processing in the channel abstraction processing in the electronic control system according to Embodiment 1;

FIG. 17 is a flowchart exemplarily representing a procedure of frame transmission monitoring processing in the channel abstraction processing in the electronic control system according to Embodiment 1;

FIG. 18 is an explanatory diagram exemplarily representing the contents of communication-related data pieces in control processing in the electronic control system according to Embodiment 1;

FIG. 19 is a flowchart exemplarily representing a procedure of initialization processing in the control processing in the electronic control system according to Embodiment 1;

FIG. 20 is a flowchart exemplarily representing a procedure of data reception processing in the control processing in the electronic control system according to Embodiment 1;

FIG. 21 is a flowchart exemplarily representing a procedure of data transmission processing in the control processing in the electronic control system according to Embodiment 1;

FIG. 22 is a flowchart exemplarily representing a procedure of data transmission completion processing in the control processing in the electronic control system according to Embodiment 1;

FIG. 23 is a flowchart exemplarily representing a procedure of data reception time-out processing in the control processing in the electronic control system according to Embodiment 1;

FIG. 24 is a flowchart exemplarily representing a procedure of data transmission time-out processing in the control processing in the electronic control system according to Embodiment 1;

FIG. 25 is a flowchart exemplarily representing a procedure of periodic processing in the control processing in the electronic control system according to Embodiment 1;

FIG. 26 is a flowchart exemplarily representing a procedure of control-related processing in the control processing in the electronic control system according to Embodiment 1;

FIG. 27 is an explanatory diagram exemplarily representing respective contents of variables to be accessed by a communication part of a testing program in the electronic control system according to Embodiment 1;

FIG. 28 is an explanatory diagram exemplarily representing the contents of a communication part of the testing program in the electronic control system according to Embodiment 1;

FIG. 29 is a flowchart exemplarily representing a procedure of periodic processing in the testing processing in the electronic control system according to Embodiment 1;

FIG. 30 is a flowchart exemplarily representing a procedure of test-related processing in the testing processing in the electronic control system according to Embodiment 1;

FIG. 31 is a flowchart exemplarily representing a procedure of ECU transmission ascertainment processing in the testing processing in the electronic control system according to Embodiment 1; and

FIG. 32 is a flowchart exemplarily representing a procedure of test failure processing in the testing processing in the testing apparatus according to Embodiment 1.

### DETAILED DESCRIPTION OF THE PREFERRED EMBODIMENTS

Hereinafter, an electronic control system, an electronic-control-system testing apparatus, and an electronic-control-system testing method according to Embodiment 1 will be explained by use of drawings. In each of the drawings, the same constituent elements are designated by the same reference characters.

### Embodiment 1

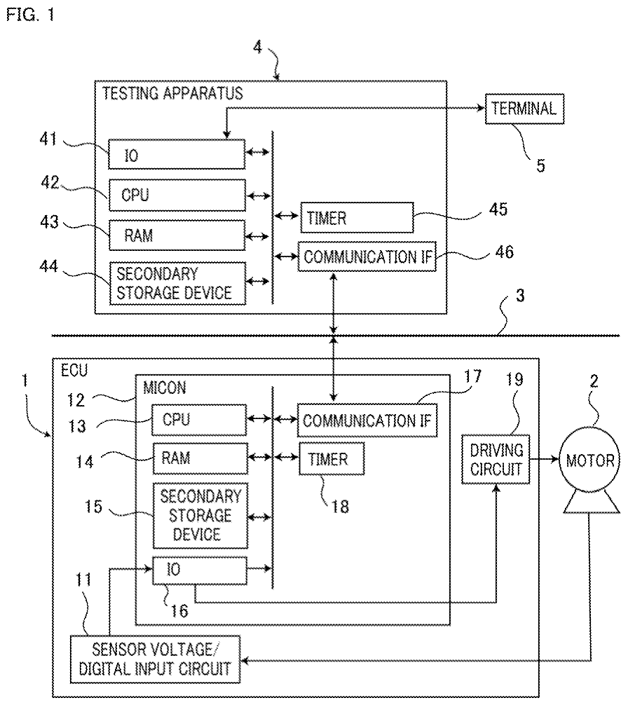

FIG. 1 is a configuration diagram representing an electronic control system and a testing apparatus according to Embodiment 1; a motor to be driven by the electronic control system is also represented.

In FIG. 1, an ECU 1 as the electronic control system has a sensor voltage/digital input circuit 11, a MICON 12, and a driving circuit 19. The ECU 1 is configured to control a motor 2. In addition, through a communication line 3, the ECU 1 is communicatively connected with a testing apparatus 4 for testing the behavior of the ECU 1.

The MICON 12 operates as a control unit in the ECU 1. In addition, the MICON is an abbreviation of a Micro Controller Unit or a Microcomputer. The MICON 12 includes a CPU 13, a RAM (Random Access Memory) 14, a secondary storage device 15, an IO (Input/Output) 16, a communication IF (Interface) 17, and a timer 18. It may be allowed that the MICON 12 is replaced by an SoC (System on a Chip), a PC (Personal Computer), or the like, which has a scale larger than that of a MICON, as long as the foregoing functions are provided.

The CPU 13 is a control unit that controls the foregoing units in the ECU 1. The CPU 13 can execute an after-mentioned control program 150, represented in FIG. 3, that is stored in the secondary storage device 15. When an interruption occurs during the execution of the control program 150, the CPU 13 can execute processing corresponding to the interruption. The CPU 13 may be formed of two or more CPUs as long as the RAM 14, the secondary storage device 15, the IC 16, the communication IF 17, and the timer 18 can be accessed. The RAM 14 is a storage unit that can be accessed by the CPU 13 and stores data in a rewritable manner.

The testing apparatus 4 according to Embodiment 1 is communicatively connected with the ECU 1 as the electronic control system according to Embodiment 1, through the communication line 3. The details of the testing apparatus 4 will be described later.

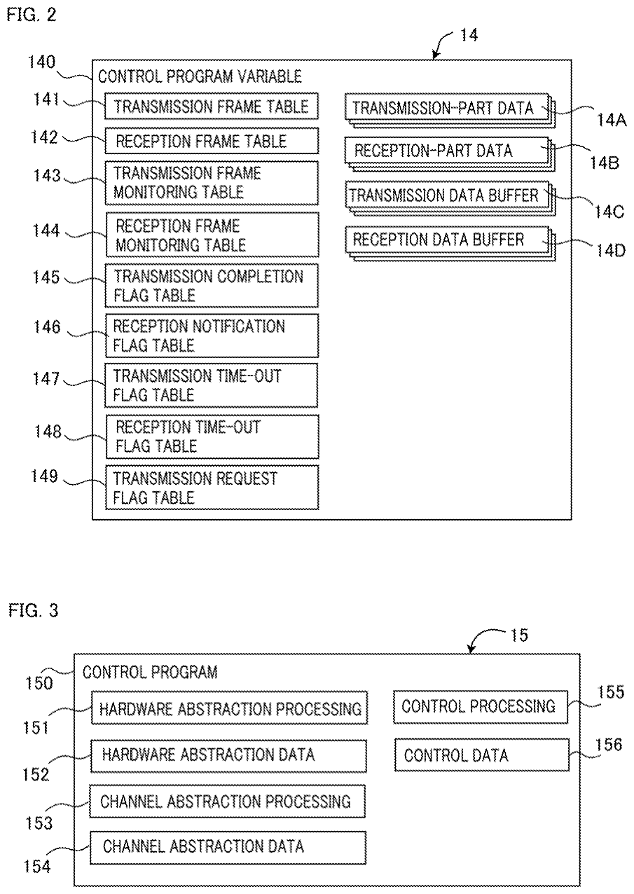

FIG. 2 is an explanatory diagram representing respective contents of variables to be accessed by a communication part of the control program in the electronic control system according to Embodiment 1. A control program variable 140 in FIG. 2 exemplarily represents respective contents of the variables of the communication part of the after-mentioned control program 150, in FIG. 3, that is stored in and updated by the RAM 14 in the ECU 1, which is the electronic control system according to Embodiment 1. The control program variable 140 includes respective variables, i.e., a transmission frame table 141, a reception frame table 142, a transmission frame monitoring table 143, a reception frame monitoring table 144, a transmission completion flag table 145, a reception notification flag table 146, a transmission time-out flag table 147, a reception time-out flag table 148, a transmission request flag table 149, a transmission-part data 14A, a reception-part data 14B, a transmission data buffer 14C, and a reception data buffer 14D. The application items of the variables will be explained in detail along with the after-mentioned control program 150.

In FIG. 1, the secondary storage device 15 in the ECU 1 is a storage unit that stores data in a state where only readout is possible. In this regard, however, the secondary storage device 15 may be a storage device, such as an EPROM (Erasable Programmable Read Only Memory), a NOR-type flash memory, or a NAND-type flash memory, that can rewrite data according to a specific method. In the case where the CPU 13 cannot directly execute the control program 150 stored in the secondary storage device 15 by use of a NAND-type flash memory or the like, it may be allowed that the contents of the control program 150 is transferred from the secondary storage device 15 to the RAM 14 and then the control program 150 is executed by use of the RAM 14. The contents of the control program and the data to be stored by the secondary storage device 15 will be explained in detail later.

The IO 16 performs input and output of a sensor voltage and a digital signal from a digital input circuit. Specifically, the IO 16 takes a voltage read by the sensor voltage/digital input circuit 11 into the MICON 12 and outputs a control signal to the driving circuit 19.

The communication IF 17 is utilized to communicate with other apparatuses provided outside the electronic control system 1; in Embodiment 1, the communication IF 17 is utilized to communicate with the testing apparatus 4 through the communication line 3. Accordingly, the communication IF 17 performs communication by use of a telecommunication standard the same as that for a communication IF 46 in the testing apparatus 4. The communication IF 17 is configured in such a way as to be able to communicate with external apparatuses, based on any one of various kinds of communication standards such as CAN (Controller Area Network), CAN FD (CAN with Flexible Data-Rate), FlexRay, and Ethernet. In some cases, the communication IF 17 is provided with two or more communication channels, which are communication functions having the same standard; in the case where two or more communication channels are utilized, two or more communication lines 3 are connected in parallel with the communication IF 17. The communication IF 17 may communicate with external apparatuses through wireless communication.

Its behavior of measuring elapsed time is started or stopped by the CPU 13, so that the timer 18 notifies the CPU 13 of the elapsed time. A dedicated register provided in the timer 18 is read by the CPU 13, so that the elapsed time measured by the timer 18 can be obtained; when a preliminarily set time has elapsed, the timer 18 can notify the CPU 13 in an interrupting manner that the preliminarily set time has elapsed.

The driving circuit 19 receives an instruction from the MICON 12 and then generates a motor driving signal that is supplied to the motor 2. In Embodiment 1, there is described a specific example in which the ECU 1 drives the motor 2; however, the configuration of the ECU 1 is not limited to the specific example. For example, the ECU 1 may be configured in such a way that the control subject of the driving circuit 19 is a light source such as an LED (Light Emitting Diode) and the ECU 1 performs illumination control of the LED.

FIG. 3 is an explanatory diagram representing the contents of the communication part of the control program in the electronic control system according to Embodiment 1; the contents of the communication part of the control program 150 to be stored in the secondary storage device 15 are exemplarily represented. The control program 150 includes hardware abstraction processing 151, hardware abstraction data 152, channel abstraction processing 153, channel abstraction data 154, control processing 155, and control data 156.

In the hardware abstraction processing 151 is a processing hierarchy that mainly performs the following matters: when the respective functions of the communication IF 17 are utilized, an appropriate value is written in a setting register to be inherently provided for each of the functions and the value is read from a register that indicates a state, so that a target function is executed and it is obtained whether or not the function has correctly been executed; in the case where the function has correctly been executed, the execution result is obtained. When various kinds of functions of a MICON are utilized, the hardware abstraction processing 151 conceals detailed setting and reading of a register from external processing and abstracts them.

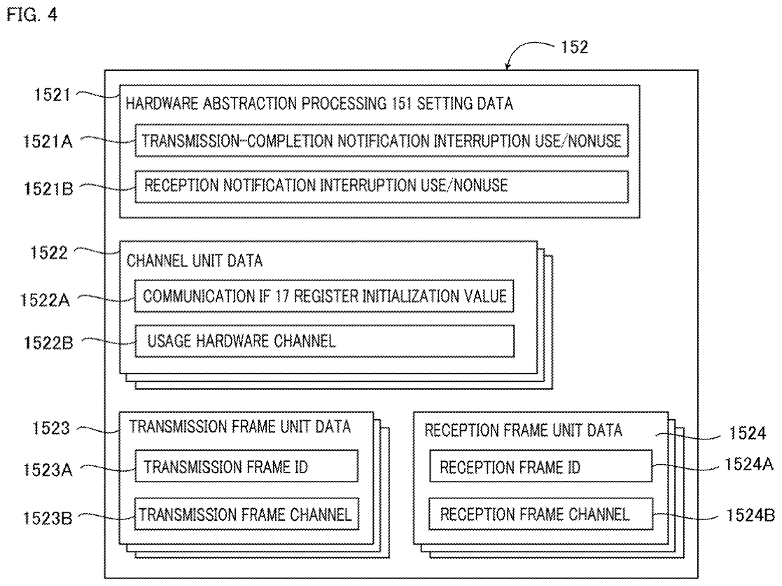

FIG. 4 is an explanatory diagram exemplarily representing main hardware abstraction data pieces to which with regard to communication, hardware abstraction processing refers in the electronic control system according to Embodiment 1; main data pieces, related to communication, out of the hardware abstraction data 152 to be referred to by the hardware abstraction processing 151 are exemplarily represented.

In FIG. 4, the hardware abstraction data 152 is created based on a communication-request specification of the ECU 1. In Embodiment 1, as a configuration example of the hardware abstraction data 152, there are created hardware abstraction processing 151 setting data 1521 for determining behavior of the hardware abstraction processing 151, channel unit data 1522 for storing a request value for each communication channel, transmission frame unit data 1523 for storing a request value for each transmission frame, and reception frame unit data 1524 for storing a request value for each reception frame.

The hardware abstraction processing 151 setting data 1521 is data for determining behavior of the hardware abstraction processing 151; in Embodiment 1, the hardware abstraction processing 151 setting data 1521 includes transmission-completion notification interruption use/nonuse 1521A for determining whether or not in communication, interruption for giving notice of frame-transmission completion is used or unused and reception notification interruption use/nonuse 1521B for determining whether or not interruption for giving notice of frame reception is used or unused. In the case where values for utilizing the foregoing interruptions are taken, the hardware abstraction processing 151 sets the communication IF 17 in such a way that when transmission of a frame is completed or a frame is received, the communication IF 17 notifies the CPU 13 of the transmission completion or the reception in an interrupting manner. In the case where values for disusing the foregoing interruptions are taken, it is required to periodically ascertain with the communication IF 17 whether or not these events have occurred, because the communication IF 17 does not notify the CPU 13 of the occurrence of these events.

The transmission-completion notification interruption use/nonuse 1521A and the reception notification interruption use/nonuse 1521B may not be direct requests in the communication-request specification of the ECU 1; however, taking the total number of frames to be handled by the hardware abstraction processing 151, the performance of the MICON 12 to be used, the effect provided by occurrence of interruption to the execution timing for control processing 155, and the like into consideration, the setting needs to be performed in such a way that frame transmission/reception in the communication-request specification can be dealt with according to a request and without delay.

The channel unit data 1522 is exemplarily represented information, on a single communication channel, that is referred to by the hardware abstraction processing 151; in Embodiment 1, there are created a communication IF 17 register initialization value 1522A for storing respective initial values of various kinds of registers provided in the communication IF 17 and a usage hardware channel 1522B for storing which one of communication channels to be provided by the communication IF 17 is utilized. The number of the channel unit data pieces 1522 to be created is the same as the number of communication channels to be requested in the communication-request specification of the ECU 1.

The transmission frame unit data 1523 is exemplarily represented information, on a single transmission frame, that is referred to by the hardware abstraction processing 151; in Embodiment 1, there are created a transmission frame ID 1523A for storing an inherent value for each transmission frame and a transmission frame channel 1523B for storing which one of communication channels to be provided by the communication IF 17 is utilized for transmission. The number of the transmission frame unit data pieces 1523 to be created is the same as the number of transmission frames to be requested in the communication-request specification of the ECU 1.

The reception frame unit data 1524 is exemplarily represented information, on a single reception frame, that is referred to by the hardware abstraction processing 151; in Embodiment 1, there are created a reception frame ID 1524A for defining an inherent value for each reception frame and a reception frame channel 1524B for storing which one of communication channels to be provided by the communication IF 17 is utilized for reception. The number of the reception frame unit data pieces 1524 to be created is the same as the number of reception frames to be requested in the communication-request specification of the ECU 1.

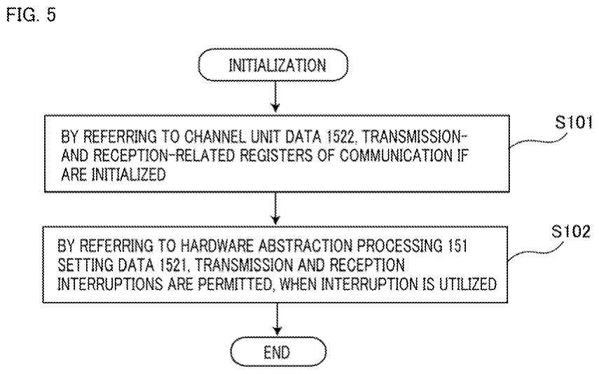

Each of FIGS. 5 through 9 is a flowchart that exemplarily represents main communication-related processing contents of the hardware abstraction processing 151; hereinafter, main communication-related processing contents in the hardware abstraction processing 151 will be explained in detail, based on each of the flowcharts.

FIG. 5 is a flowchart representing a procedure of communication-related initialization processing in the hardware abstraction processing in the electronic control system according to Embodiment 1; communication-related initialization processing in the hardware abstraction processing 151 is represented. In FIG. 5, in the step S101, by referring to the communication IF 17 register initialization value 1522A and the usage hardware channel 1522B for each communicate channel, the transmission- and reception-related registers of the communication IF 17 are set so that transmission and reception of a frame becomes possible. Next, in the step S102, by referring to the hardware abstraction processing 151 setting data 1521, the setting is performed in such a way that when transmission of a frame requesting transmission is completed or when a frame from the outside is received, the communication IF 17 can notify the CPU 13 of the event in an interrupting manner or transmission or reception of a frame can periodically be ascertained without utilizing the interruption.

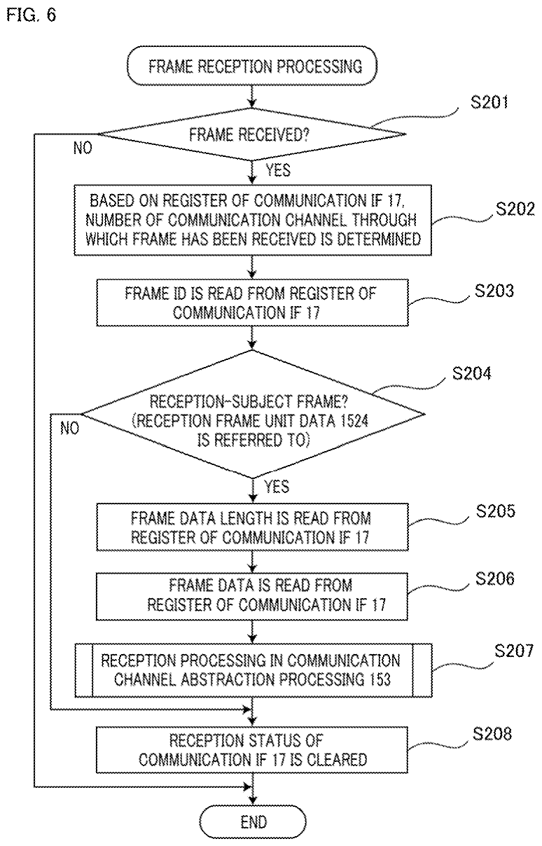

FIG. 6 is a flowchart representing a procedure of frame reception processing in the hardware abstraction processing in the electronic control system according to Embodiment 1; frame reception processing in the hardware abstraction processing 151 is represented. The frame reception processing represented in FIG. 6 is executed in the case where when a communication frame from the outside is received, the communication IF 17 generates an interruption to the CPU 13 or is periodically executed without utilizing any interruption. In FIG. 6, at first, in the step S201 of the frame reception processing, it is ascertained by referring to a register of the communication IF 17 whether or not a frame has been received; in the case where no frame has been received (NO), the processing is ended.

In the case where in the step S201, reception of a frame has been confirmed (YES), the step S201 is followed by the step S202, where the number of the communication channel through which the frame has been received is determined. In the step S203, the frame ID of the received frame is read from the register of the communication IF 17 and is stored in the RAM 14. Next, in the step S204, it is determined by referring to the reception frame unit data pieces 1524 represented in FIG. 4 whether or not the frame ID received through the foregoing communication channel is of a reception subject; in the case where the frame is not a reception subject (NO), the step S204 is followed by the step S208, where the reception status of the communication IF 17 is cleared to a “non-reception state”; then, the reception processing is ended.

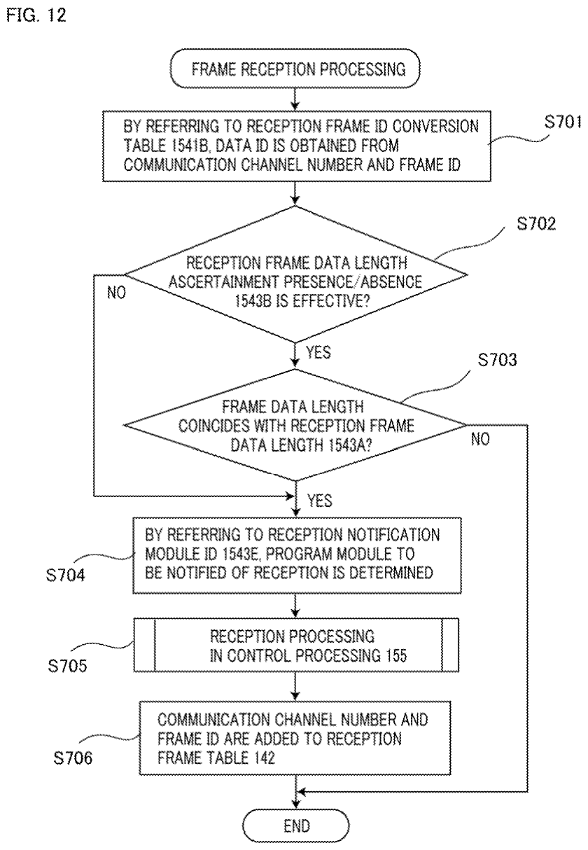

In the case where it is determined in the step S204 that a reception-subject frame has been received (YES), the step S204 is followed by the step S205, where a frame data length (byte number) is read from the register of the communication IF 17; then, in the step S206, frame data pieces corresponding to the frame data length are read from the register of the communication IF 17, and then the data length of the received data and the data are stored in the RAM 14. In the step S207, the communication channel number, the frame ID, the frame data length, and the frame data of the received frame are transferred, as parameters for reception processing in the channel abstraction processing 153, to an after-mentioned frame reception processing represented in FIG. 12. Next, in the step S208, the reception status of the communication IF 17 is cleared to the “non-reception state”; then, the reception processing is ended.

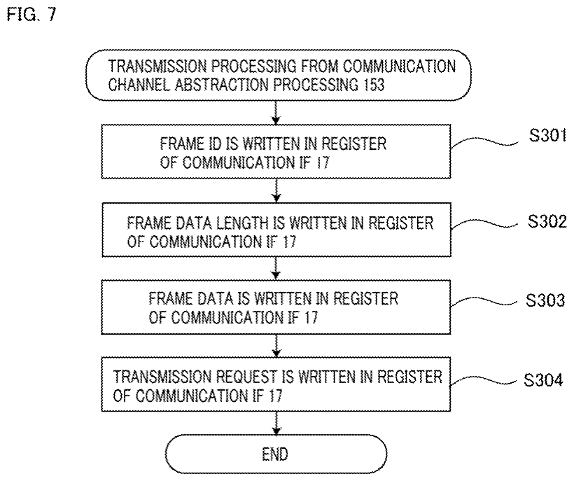

FIG. 7 is a flowchart representing a procedure of frame transmission processing in the hardware abstraction processing in the electronic control system according to Embodiment 1, and represents the frame transmission processing to be executed by the foregoing hardware abstraction processing 151 in FIG. 3 when it is called by the channel abstraction processing 153.

In the frame transmission processing of the hardware abstraction processing 151 represented in FIG. 7, in the step S301, a frame ID is written in a designated communication-channel register of the communication IF 17; in the step S302, a frame data length is written in a designated communication-channel register of the communication IF 17; in the step S303, frame data is written in a designated communication-channel register of the communication IF 17; in the step S304, a frame transmission request is written in a register of the communication IF 17; then, the transmission processing is ended.

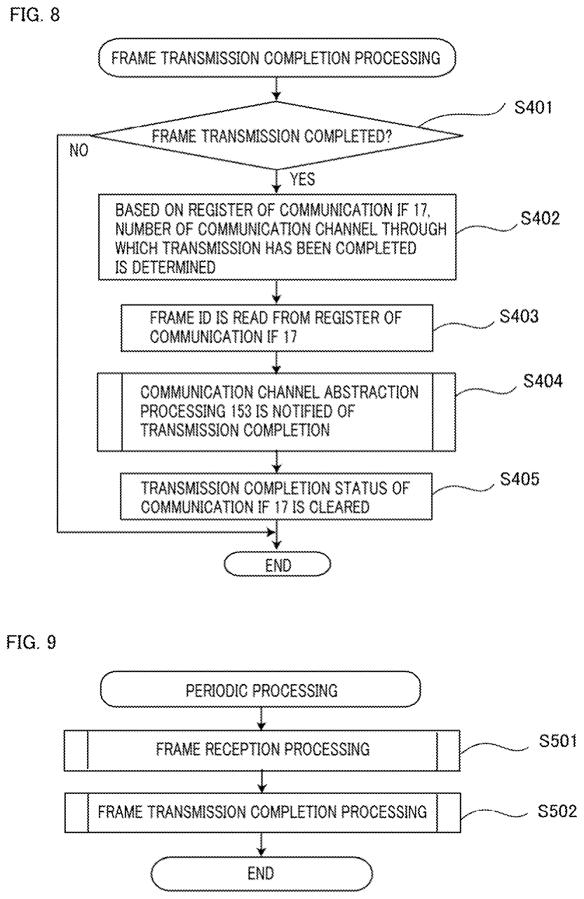

FIG. 8 is a flowchart exemplarily representing a procedure of frame transmission completion processing of the hardware abstraction processing in the electronic control system according to Embodiment 1; frame transmission completion processing of the foregoing hardware abstraction processing 151 in FIG. 3 is represented. The frame transmission completion processing in FIG. 8 is executed in the case where when transmission of a frame requested in the foregoing frame transmission processing in FIG. 7 has been completed, the communication IF 17 generates an interruption to the CPU 13 or is periodically executed without utilizing any interruption.

In FIG. 8, in the step S401, it is ascertained by referring to a register whether or not frame transmission has been completed; in the case where there exists no frame that has been transmitted (NO), the processing is ended. In the case where completion of frame transmission has been confirmed (YES), the step S401 is followed by the step S402, where the number of the communication channel through which the transmission has been completed is determined; then, in the step 403, the frame ID of the frame that has been transmitted is read from the register of the communication IF 17 and is stored in the RAM 14. Next, in the step S404, the communication channel number and the frame ID for the transmitted frame are transferred, as parameters for the transmission completion processing, to the channel abstraction processing 153. In the step S405, the transmission completion status of the communication IF 17 is cleared without completion of transmission; then, the transmission completion processing is ended.

FIG. 9 is a flowchart representing a procedure of periodic processing in the hardware abstraction processing in the electronic control system according to Embodiment 1; periodic processing of the foregoing hardware abstraction processing 151 in FIG. 3 is represented. In the step S501, when transmission of a frame has been completed or in the case where when a frame has been received, no interruption is utilized, the frame reception processing of the hardware abstraction processing 151 is periodically executed, and in the step S502, the frame transmission completion processing is executed; then, the processing is ended.

The processing period is generated, for example, by use of the timer 18.

In the channel abstraction processing 153 in the control program 150 represented in FIG. 3, the hardware abstraction processing 151 is utilized, so that the data transmission/reception function of the communication IF 17 is utilized without performing detailed operation of the register of the communication IF 17. Moreover, in the channel abstraction processing 153, in the case where two or more communication channels are utilized, information on each of the communication channels is replaced by a value for an inherent identifier (hereinafter, referred to as a “data unit ID”) so as to be concealed and abstracted.

The channel abstraction data 154 represented in FIG. 3 is data at a time when a communication request of the ECU is applied to a necessary range by the channel abstraction processing 153; a frame ID, a communication channel through which a frame is transmitted or received, and the like correspond to the data.

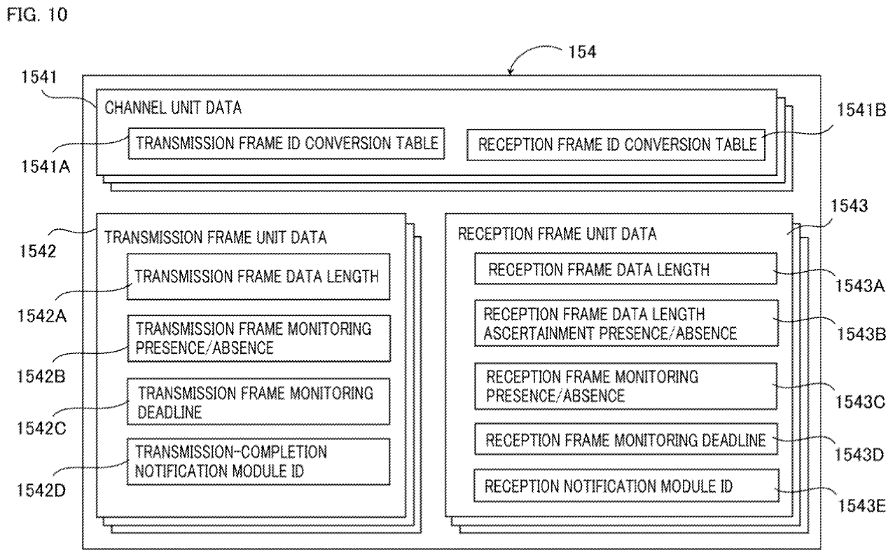

FIG. 10 is an explanatory diagram exemplarily representing main communication channel abstraction data pieces to which the channel abstraction processing refers in the electronic control system according to Embodiment 1; main data pieces in the channel abstraction data 154 to which the foregoing channel abstraction processing 153 in FIG. 3 refers are exemplarily represented.

In FIG. 10, the channel abstraction data 154 is created based on a communication-request specification of the ECU 1. In Embodiment 1, as a configuration example of the channel abstraction data 154, there are created channel unit data 1541 for storing a request value for each channel, transmission frame unit data 1542 for storing a request value for each transmission frame, and reception frame unit data 1543 for storing a request value for each reception frame.

The channel unit data 1541 is exemplarily represented information, on a single communication channel, that is referred to by the channel abstraction processing 153; in Embodiment 1, there are created a transmission frame ID conversion table 1541A for converting a set of the communication channel number for a transmission frame and a transmission frame ID into an inherent ID (hereinafter, referred to as a “data ID”) and a reception frame ID conversion table 1541B for converting a set of the communication channel number for a reception frame and a reception frame ID into data ID.

When receiving a transmission-completion notification or a reception notification from the hardware abstraction processing 151, the transmission frame ID conversion table 1541A or, as the case may be, the reception frame ID conversion table 1541B integrates the communication channel number and the frame ID into a single inherent ID (hereinafter, referred to as a “data ID”) and notifies a higher-processing-hierarchy program module (the control processing 155, in Embodiment 1) of the data ID. A data ID may be created in an arbitrary manner, as long as it is an inherent value that does not overlap with another frame; for example, a serial number may simply be allocated to each frame; alternatively, it may be allowed that a 16-bit storage width is secured for each data ID, a communication channel number is stored in the 4 high-order bits thereof, and then a frame ID obtained from the register, of the communication IF 17, that corresponds to the communication channel number.

When receiving a transmission request from a higher-processing-hierarchy program module, the channel abstraction processing 153 receives a data ID and transmission data from the higher-processing-hierarchy program module. It is required that the foregoing channel abstraction processing 153 in FIG. 3 obtains the communication channel number and the frame ID corresponding to the received data ID and then transfers the communication channel number, the frame ID, and the transmission data to the hardware abstraction processing 151. Therefore, it is required that the transmission frame ID conversion table 1541A can not only obtain a data ID from the communication channel number and the frame ID of a transmission frame but also can obtain a communication channel number and a transmission frame ID from a data ID. In the case where it is difficult to efficiently perform this bilateral conversion with a single table, it may be allowed that two kinds of tables that make it possible to efficiently perform the conversion are created for the respective conversion directions.

The number of the channel unit data pieces 1541 to be created is the same as the number of communication channels to be requested in the communication-request specification of the ECU 1.

The transmission frame unit data 1542 is exemplarily represented information, on a single transmission frame, that is referred to by the channel abstraction processing 153; in Embodiment 1, there are created a transmission frame data length 1542A for storing the size of net data in a transmission frame, a transmission frame monitoring presence/absence 1542B for storing whether or not it is monitored that transmission of a transmission frame has been completed within a deadline, a transmission frame monitoring deadline 1542C for storing a transmission time-out time for a transmission frame, and a transmission-completion notification module ID 1542D for storing a higher-hierarchy program module ID that gives notice of transmission completion of a transmission frame. The number of the transmission frame unit data pieces 1542 to be created is the same as the number of transmission frames to be requested in the communication-request specification of the ECU 1.

The reception frame unit data 1543 is exemplarily represented information, on a single reception frame, that is referred to by the channel abstraction processing 153; in Embodiment 1, there are created a reception frame data length 1543A for storing the length of net data in a reception frame, a reception frame data length ascertainment presence/absence 1543B for storing whether or not the length of net data in a reception frame is ascertained, a reception frame monitoring presence/absence 1543C for storing whether or not reception of a reception frame is monitored, a reception frame monitoring deadline 1543D for storing a reception time-out time for a reception frame, and a reception notification module ID 1543E for storing a higher-hierarchy program module ID that gives notice of reception of a reception frame. The number of the reception frame unit data pieces 1543 to be created is the same as the number of reception frames to be requested in the communication-request specification of the ECU 1.

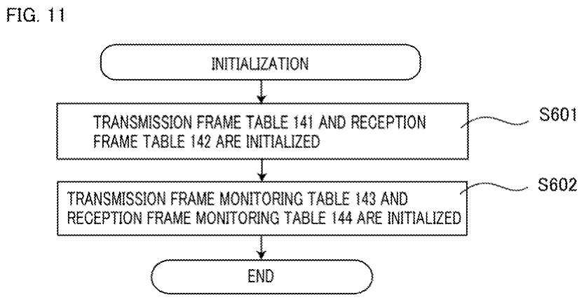

Each of FIGS. 11 through 17 is a flowchart that exemplarily represents main processing contents of the channel abstraction processing 153. Hereinafter, based on the flowchart represented in each of FIGS. 11 through 17, the processing contents of the channel abstraction processing 153 will be explained in detail.

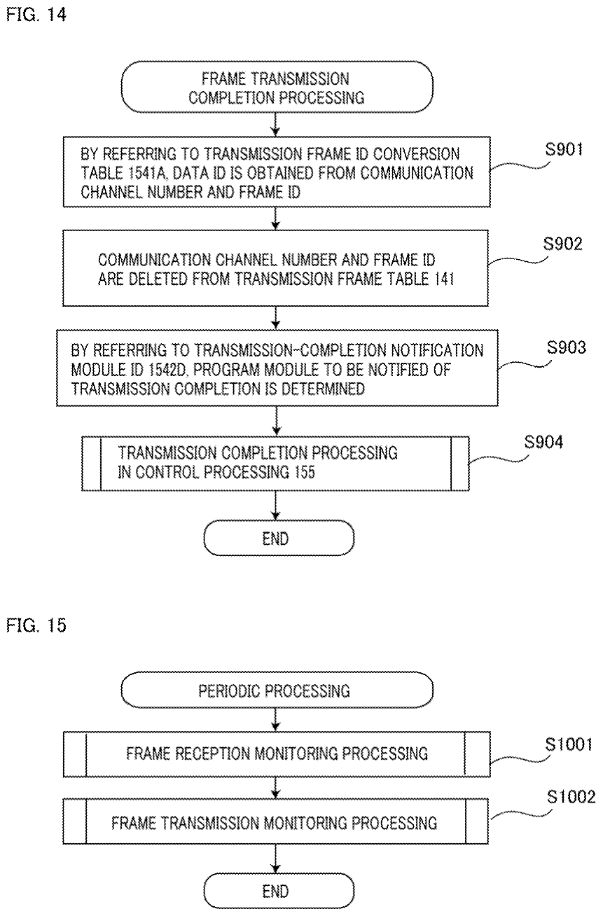

FIG. 11 is a flowchart exemplarily representing a procedure of initialization processing in the channel abstraction processing in the electronic control system according to Embodiment 1; the initialization processing of the channel abstraction processing 153 is represented. In FIG. 11, in the step S601, the transmission frame table 141 and the reception frame table 142 are initialized; in the step S602, the transmission frame monitoring table 143 and the reception frame monitoring table 144 are initialized. When required, setting or initialization for periodically calling periodic processing represented in after-mentioned FIG. 14 may be performed within the processing in FIG. 11.

FIG. 12 is a flowchart exemplarily representing a procedure of frame reception processing in the channel abstraction processing in the electronic control system according to Embodiment 1; the frame reception processing in the channel abstraction processing 153 is represented. When a frame is received, the channel number of the received frame, the frame ID, the frame data length, and the frame data that have been received, as the parameters, are transferred from the step S207 for the reception processing in the hardware abstraction processing 151 in FIG. 7, and then are called. With regard to the frame reception processing in the channel abstraction processing 153 represented in FIG. 12, in the step S701, a data ID is obtained from the channel number and the frame ID by referring to the reception frame ID conversion table 1541B.

Next, in the step S702, it is ascertained whether or not the reception frame data length ascertainment presence/absence 1543B is effective; in the case where the reception frame data length ascertainment presence/absence 1543B is effective (YES), the step S702 is followed by the step S703, where it is ascertained whether or not the frame data length corresponds to the reception frame data length 1543A. In the case where it is ascertained in the step S703 that the frame data length does not correspond to the reception frame data length 1543A (NO), the reception processing is ended.

In the case where it is determined in the step S702 that the reception frame data length ascertainment presence/absence 1543B is effective (YES) and in the case where it is determined in the step S703 that the frame data length corresponds to the reception frame data length 1543A (YES), the step S703 is followed by the step S704, where by referring to the reception notification module ID 1543E, the higher-processing-hierarchy program module for giving notice of reception of a frame is determined; then, in the step S705, the data ID and the frame data, as parameters, are transferred to a higher-processing-hierarchy frame reception processing so as to give notice of reception of the data. In Embodiment 1, the higher-processing-hierarchy program module is the control processing 155; however, the higher-processing-hierarchy program module is not limited thereto, and it may be allowed that the control processing 155 is divided into two or more processing steps or is another kind of program module. At last, in the step S706, the communication channel number and the frame ID are added to the reception frame table 142; then, the reception processing is ended.

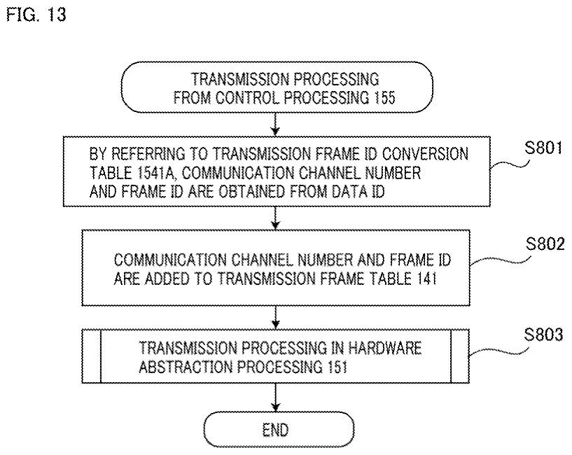

FIG. 13 is a flowchart representing a procedure of frame transmission processing in the channel abstraction processing in the electronic control system according to Embodiment 1; when called, as transmission processing, by the control processing 155, this frame transmission processing is executed by the channel abstraction processing 153, the data ID and the frame data to be transmitted as processing parameters are transferred.

With regard to the frame reception processing of the channel abstraction processing 153 represented in FIG. 13, in the step S801, the communication channel number and the frame ID is obtained from the data ID by referring to the transmission frame ID conversion table 1541A. Next, in the step S802, the communication channel number and the frame ID are added to the transmission frame table 141. In the step S803, the communication channel number of a frame, the frame ID, the frame data length, and the frame data that are transmitted, as parameters, are transferred to the hardware abstraction processing 151 and are called; then, the transmission processing is ended.

FIG. 14 is a flowchart exemplarily representing a procedure of frame transmission completion processing in the channel abstraction processing in the electronic control system according to Embodiment 1; the frame transmission completion processing of the channel abstraction processing 153 is represented. When transmission of the frame requested in the foregoing frame transmission processing is completed, the communication channel number and the frame ID of the transmitted frame, as parameters, are transferred from the step S405 for the frame transmission completion processing in the hardware abstraction processing 151 and are called.

With regard to the frame transmission completion processing of the channel abstraction processing 153 represented in FIG. 14, in the step S901, the data ID is obtained from the communication channel number and the frame ID by referring to the transmission frame ID conversion table 1541A. Next, in the step S902, the communication channel number and the frame ID are deleted from the transmission frame table 141; then, in the step S903, a higher-processing-hierarchy program module for give notice of completion of frame transmission, by referring to the transmission-completion notification module ID 1542D. Then, in the step S904, the data ID, as a parameter, is transferred to the higher-processing-hierarchy frame transmission completion processing so as to give notice of completion of data transmission; then, the processing is ended.

FIG. 15 is a flowchart exemplarily representing a procedure of periodic processing in the channel abstraction processing in the electronic control system according to Embodiment 1; the periodic processing in the channel abstraction processing 153 is represented and is periodically called by use of a scheduler of an OS (Operating System), the timer 18, or the like. The calling period is determined in such a way as to be neither too long nor too short for a response time required for the channel abstraction processing 153. Each time the periodic processing represented in FIG. 15 is called, frame reception monitoring processing according to the step S1001 and frame transmission monitoring processing according to the step S1002 are called.

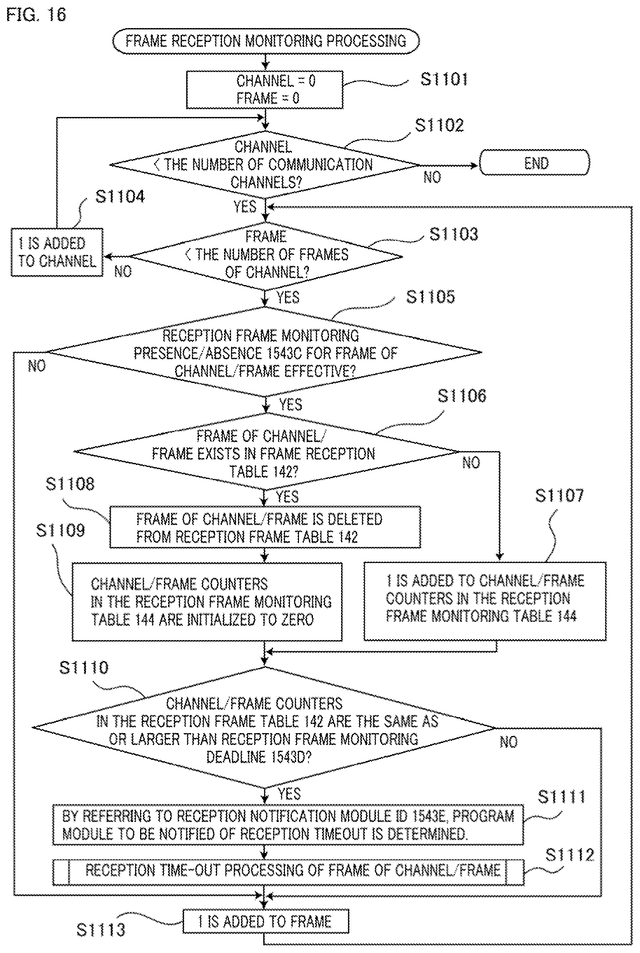

FIG. 16 exemplarily represents a procedure of frame reception processing in the channel abstraction processing in the electronic control system according to Embodiment 1; the frame reception monitoring processing, in the channel abstraction processing 153, that is periodically performed is represented; at first, the step S1001 is called.

In the step S1101, an automatic variable CHANNEL and an automatic variable FRAME are initialized to “0”; then, in the step S1102, it is determined whether or not the automatic variable CHANNEL is smaller than the number of communication channels. In the case where the automatic variable CHANNEL is smaller than the number of communication channels (YES), the step S1102 is followed by the step S1103, where it is determined whether or not the automatic variable FRAME is smaller than the number of frames in the automatic variable CHANNEL; in the case where the automatic variable FRAME is not smaller than the number of frames in the automatic variable CHANNEL (NO), the step S1103 is followed by the step S1104. In the step S1104, “1” is added to the automatic variable CHANNEL; then, the step S1102 is resumed.

In the case where it is determined in the foregoing step S1102 that the automatic variable CHANNEL is not smaller than the number of communication channels (NO), the processing is ended. In the case where it is determined in the step S1103 that the automatic variable FRAME is smaller than the number of frames in the automatic variable CHANNEL (YES), the step S1103 is followed by the step S1105. According to steps S1102, S1103, and S1104, the frame reception monitoring processing is repeated as many times as the number of frames to be received through the communication channel number of each of the automatic variables CHANNEL.

In the step S1105, with regard to the frame ID of each of the respective automatic variables FRAME of the communication channel numbers of the automatic variables CHANNEL, it is determined whether or not the reception frame monitoring presence/absence 1543C of the corresponding frame is effective; in the case where the reception frame monitoring presence/absence 1543C of the corresponding frame is ineffective (NO), “1” is added to the automatic variable FRAME; then, in the step S1113, the monitoring processing is applied to the next reception frame. In contrast, in the case where it is determined in the step S1105 that the reception frame monitoring presence/absence 1543C of the corresponding frame is effective (YES), the step S1105 is followed by the step S1106, where it is determined whether or not a frame of the automatic variable CHANNEL and the automatic variable FRAME exists in the reception frame table 142. In the case where a frame of the automatic variable CHANNEL and the automatic variable FRAME exists in the reception frame table 142 (YES), i.e., in the case where a frame having the communication channel number of the automatic variable CHANNEL and the frame ID of the automatic variable FRAME has been added to the reception frame table 142, the step S1106 is followed by the step S1108.

In the step S1108, the foregoing frame is deleted from the reception frame table 142; then, in the step S1109, the corresponding counter of the reception frame monitoring table 144 is initialized to “0”. In the case where it is determined in the step S1106 that no frame of the automatic variable CHANNEL and the automatic variable FRAME exists in the reception frame table 142 (NO), i.e., in the case where no frame having the communication channel number of the automatic variable CHANNEL and the frame ID of the automatic variable FRAME has been added to the reception frame table 142, the step S1106 is followed by the step S1107, where “1” is added to the corresponding counter of the reception frame monitoring table 144.

Next, in the step S1110, it is determined whether or not the counter of the automatic variable CHANNEL and the automatic variable FRAME in the reception frame table 142 is larger than the reception frame monitoring deadline 1543D; in the case where the value of the counter, in the reception frame monitoring table 144, of a frame having the communication channel number of the automatic variable CHANNEL and the frame ID of the automatic variable FRAME is the same as or larger than the value of the corresponding reception frame monitoring deadline 1543D (YES), the step S1110 is followed by the step S1111, where by referring to the reception notification module ID 1543E, the higher-processing-hierarchy program module for giving notice of reception time-out is determined. Next, in the step S1112, the data ID, as a parameter, is transferred to the higher-processing-hierarchy frame reception time-out processing so as to give notice of the time-out of data reception. In the case where the result of the determination in the step S1110 is negative (NO), the step S1110 is followed by the step S1113.

In the step S1113, in the case where after the time-out has been notified, the counter value of the reception frame monitoring table 144 for a frame having the communication channel number of the automatic variable CHANNEL and the frame ID of the automatic variable FRAME is smaller than the corresponding reception frame monitoring deadline 1543D, “1” is added to the automatic variable FRAME; then, the monitoring processing is applied to the next reception frame.

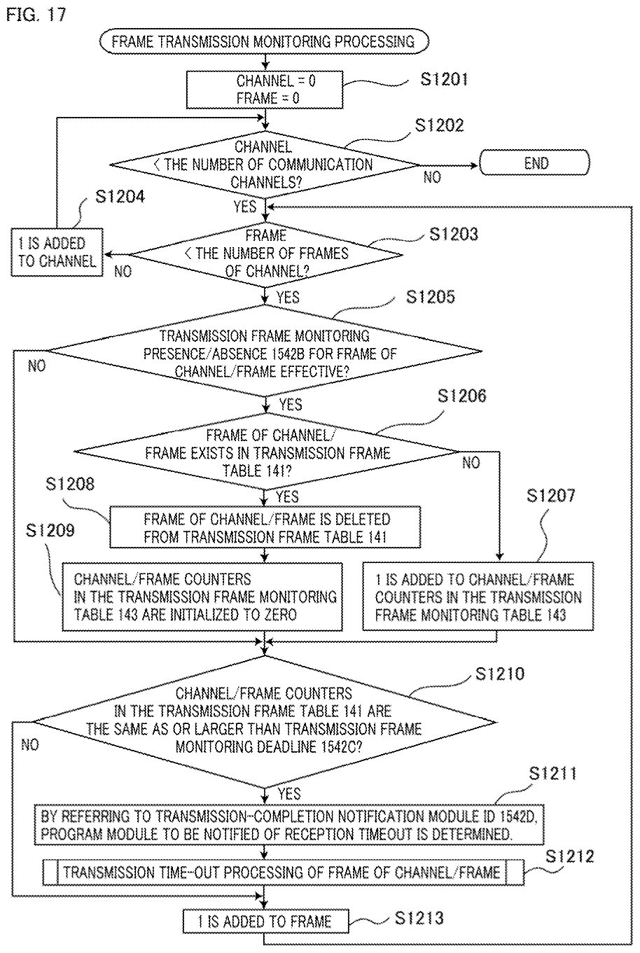

FIG. 17 is a flowchart exemplarily representing a procedure of frame transmission monitoring processing in the channel abstraction processing in the electronic control system according to Embodiment 1; the frame transmission monitoring processing, in the channel abstraction processing 153, that is periodically performed is represented; at first, the step S1201 is called.

In the step S1201, as is the case with the foregoing frame reception monitoring processing in the channel abstraction processing 153, in the frame transmission monitoring processing in the channel abstraction processing 153, the automatic variable CHANNEL and the automatic variable FRAME are each initialized to “0”. In the step S2102, it is determined whether or not the automatic variable CHANNEL is smaller than the number of communication channels; in the case where the automatic variable CHANNEL is smaller than the number of communication channels (YES), the step S1202 is followed by the step S1203, where it is determined whether or not the automatic variable FRAME is smaller than the number of frames in the automatic variable CHANNEL; in the case where the automatic variable FRAME is not smaller than the number of frames in the automatic variable CHANNEL (NO), the step S1203 is followed by the step S1204. In the step S1204, “1” is added to the automatic variable CHANNEL; then, the step S1202 is resumed.

In the case where it is determined in the foregoing step S1202 that the automatic variable CHANNEL is not smaller than the number of communication channels (NO), the processing is ended. In the case where it is determined in the step S1203 that the automatic variable FRAME is smaller than the number of frames in the automatic variable CHANNEL (YES), the step S1203 is followed by the step S1205. According to the steps S1202, S1203, and S1204, the transmission monitoring processing is repeated as many times as the number of frames to be received through the communication channel number of each of the automatic variables CHANNEL.

In the step S1205, with regard to the frame ID of each of the respective automatic variables FRAME of the communication channel numbers of the automatic variables CHANNEL, it is determined whether or not the transmission frame monitoring presence/absence 1542B of the corresponding frame is effective; in the case where the transmission frame monitoring presence/absence 1542B of the corresponding frame is ineffective (NO), the step S1205 is followed by the step S1210; in the case where the transmission frame monitoring presence/absence 1542B of the corresponding frame is effective (YES), the step S1205 is followed by the step S1206. In the step S1206, it is determined whether or not a frame of the automatic variables CHANNEL and the automatic variable FRAME exists in the transmission frame table 141; in the case where a frame of the automatic variables CHANNEL and the automatic variable FRAME exists in the transmission frame table 141 (YES), the step S1206 is followed by the step S1208; in the case where no frame of the automatic variables CHANNEL and the automatic variable FRAME exists in the transmission frame table 141 (NO), the step S1206 is followed by the step S1207.

In the step S1208, the foregoing frame is deleted from the transmission frame table 141; then, in the step S1209, the corresponding counter of the transmission frame monitoring table 143 is initialized to “0”. In contrast, in the case where it is determined in the step S1206 that a frame having the communication channel number of the automatic variable CHANNEL and the frame ID of the automatic variable FRAME has not been added to the transmission frame table 141 (NO), the step S1206 is followed by the step S1207, where “1” is added to each of the automatic variable CHANNEL and the automatic variable CHANNEL in the transmission frame monitoring table 143; then, the step S1207 is followed by the step S1210.

In the step S1210, it is determined whether or not the counter value of each of the automatic variable CHANNEL and the automatic variable FRAME in the transmission frame table 141 is the same as or larger than the transmission frame monitoring deadline 1542C; in the case where the value of the counter, in the transmission frame monitoring table 143, of a frame having the communication channel number of the automatic variable CHANNEL and the frame ID of the automatic variable FRAME is the same as or larger than the value of the corresponding transmission frame monitoring deadline 1542C (YES), the step S1210 is followed by the step S1211, where by referring to the transmission-completion notification module ID 1542D, the higher-processing-hierarchy program module for giving notice of transmission time-out is determined. In the step S1212, the data ID, as a parameter, is transferred to the time-out processing of a frame of the automatic variable CHANNEL and the automatic variable FRAME, i.e., to a higher-processing-hierarchy frame transmission time-out processing so as to give notice of the time-out of data transmission.

In contrast, in the case where it is determined in the step S1210 that the value of the counter, in the transmission frame monitoring table 143, of a frame having the communication channel number of the automatic variable CHANNEL and the frame ID of the automatic variable FRAME is smaller than the value of the corresponding transmission frame monitoring deadline 1542C (NO), the step S1210 is followed by the step S1213. When the step S1210 or the step S1212 is followed by the step S1213, “1” is added to the automatic variable FRAME in the step S1213; then, the step S1203 is resumed, and the monitoring processing is applied to the next transmission frame.

The foregoing control processing 155 receives data distinguished by a data ID by use of the channel abstraction processing 153 and then performs control processing by use of this data; in the case where it is required to transmit the processing result to the outside, the control processing 155 transfers the data ID and data on the processing result to the transmission processing of the channel abstraction processing 153 so as to perform the transmission.

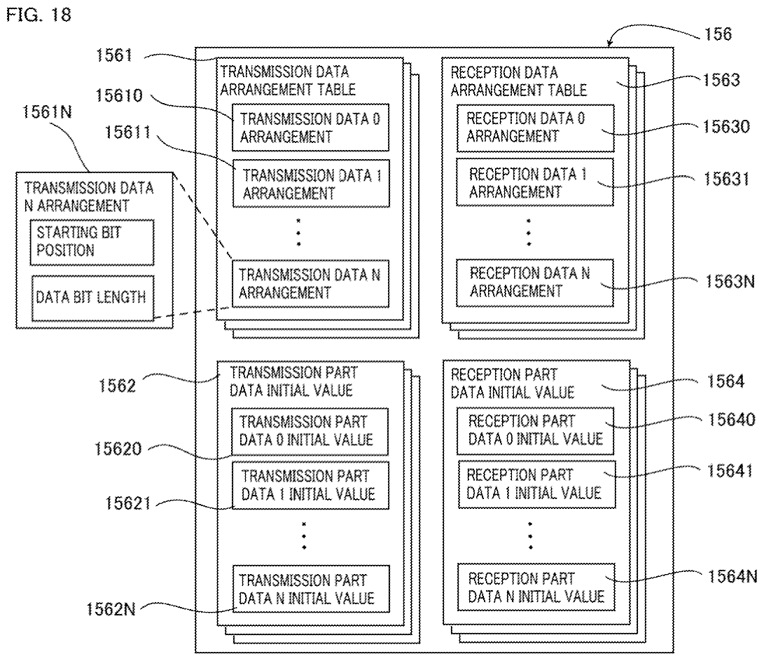

FIG. 18 is an explanatory diagram exemplarily representing the contents of communication-related data pieces in the control processing in the electronic control system according to Embodiment 1; the communication-related contents, of the control data 156, that are referred to by the control processing 155 are exemplarily represented. In FIG. 18, in Embodiment 1, as the control data 156, a transmission data arrangement table 1561, a transmission part data initial value 1562, a reception data arrangement table 1563, and a reception part data initial value 1564 are created.

The transmission data arrangement table 1561 is a table of mapping between data to be transferred to the transmission processing in the channel abstraction processing 153 and each of the respective arrangements of various kinds of data pieces, at least one of which is arranged in the foregoing data; the transmission data arrangement table 1561 is created based on the communication-request specification of the ECU 1. The data to be transferred to the channel abstraction processing 153 is generally in the form of a byte sequence; in some cases, further fragmented transmission data “0” arrangement 15610, transmission data “1” arrangement 15611, . . . , and transmission data “N” arrangement 1561N may be arranged in the byte sequence. For example, the transmission data “0” arrangement 15610 stores that the data to be transferred to the transmission processing in the channel abstraction processing 153 is arranged in which bit position from the head and how many bits are included in the data.

The transmission part data initial value 1562 stores a transmission part data “0” initial value 15620, a transmission part data “1” initial value 15621, . . . , and a transmission part data “N” initial value 1562N.

As is the case with the transmission data arrangement table 1561, the reception data arrangement table 1563 is a table of mapping between data to be transferred from the channel abstraction processing 153 during data reception processing and each of reception data “0” arrangement 15630, reception data “1” arrangement 15631, —, and reception data “N” arrangement 1563N, at least one of which is arranged in the foregoing data; the reception data arrangement table 1563 is created based on the communication-request specification of the ECU 1.

The transmission part data initial value 1564 stores a reception part data “0” initial value 15640, a reception part data “1” initial value 15641, —, and a reception part data “N” initial value 1564N of each of reception data pieces in the reception data arrangement table 1563.

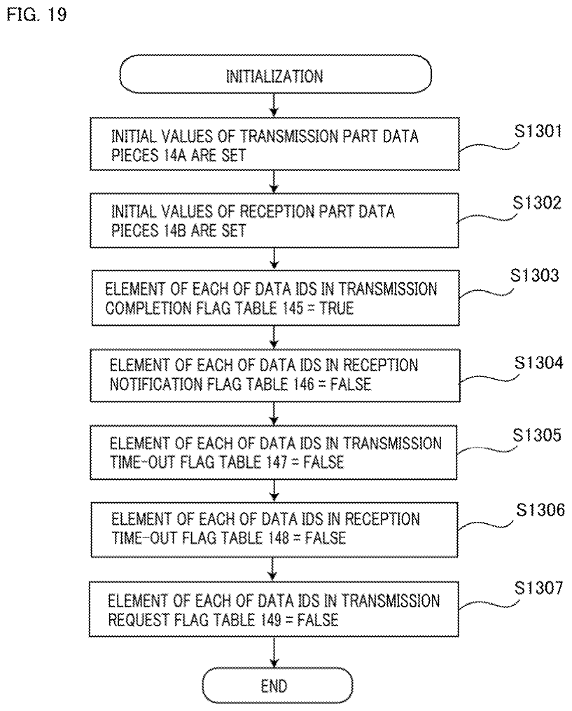

Each of FIGS. 19 through 25 is a flowchart that exemplarily represents main processing contents of the control processing 155. Hereinafter, based on the flowchart represented in each of FIGS. 19 through 25, the processing contents of the control processing 155 will be explained.

FIG. 19 is a flowchart exemplarily representing a procedure of initialization processing in the control processing in the electronic control system according to Embodiment 1. In FIG. 19, in the step S1301, the transmission part data initial values 1562 are set to the respective transmission part data pieces 14A represented in foregoing FIG. 2; in the step S1302, the reception part data initial values 1564 are set to the respective reception part data pieces 14B represented in FIG. 2.

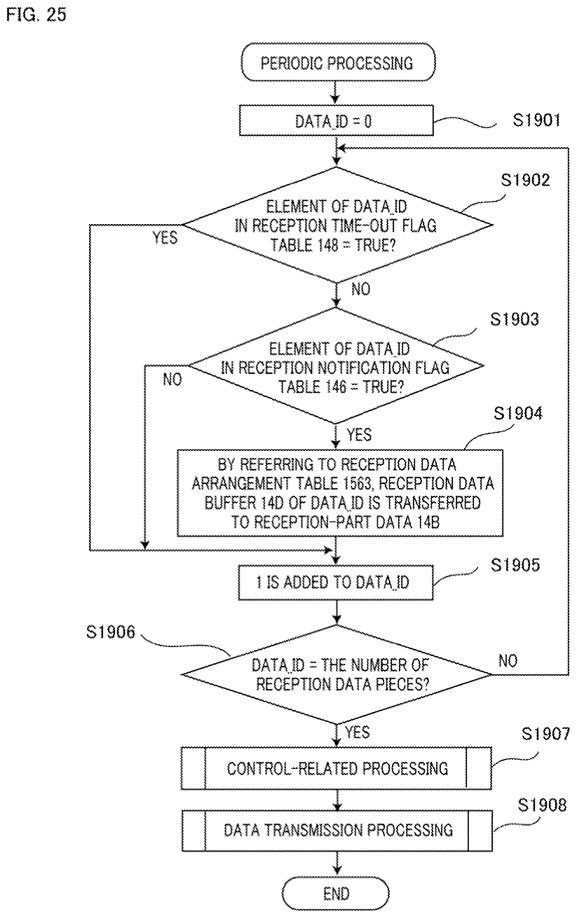

Next, in the step S1303, the element of each of the data IDs in the transmission completion flag table 145 is initialized to “TRUE”; in the step S1304, the element of each of the data IDs in the reception notification flag table 146 is initialized to “FALSE”. Next, in the step S1305, the element of each of the data IDs in the transmission time-out flag table 147 is initialized to “FALSE”; in the step S1306, the element of each of the data IDs in the reception time-out flag table 148 is initialized to “FALSE”. In the step S1307, the element of each of the data IDs in the transmission request flag table 149 is initialized to “FALSE”. When required, setting or initialization for periodically calling periodic processing represented in after-mentioned FIG. 25 may be performed within the processing in FIG. 19.

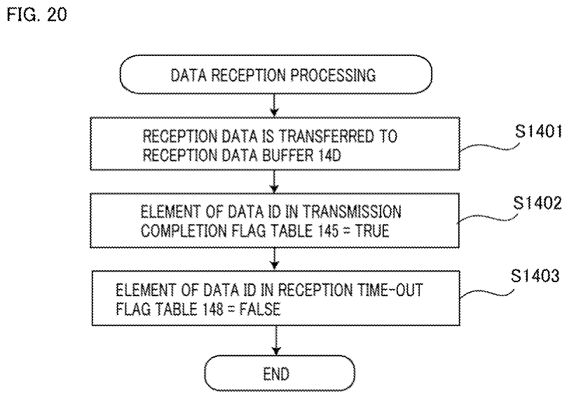

FIG. 20 is a flowchart exemplarily representing a procedure of data reception processing in the control processing in the electronic control system according to Embodiment 1; the data reception processing receives a data ID and data, as parameters, from the step S705 for the reception processing in the foregoing channel abstraction processing 153 and then is called. In the data reception processing, represented in FIG. 20, of the control processing 155, the transferred reception data is further transferred to the reception data buffer 14D in the step S1401; in the step S1402, the element of the data ID in the transmission completion flag table 145 is set to “TRUE”; next, in the step S1403, the element of the data ID in the reception time-out flag table 148 is set to “FALSE”; then, the processing is ended.

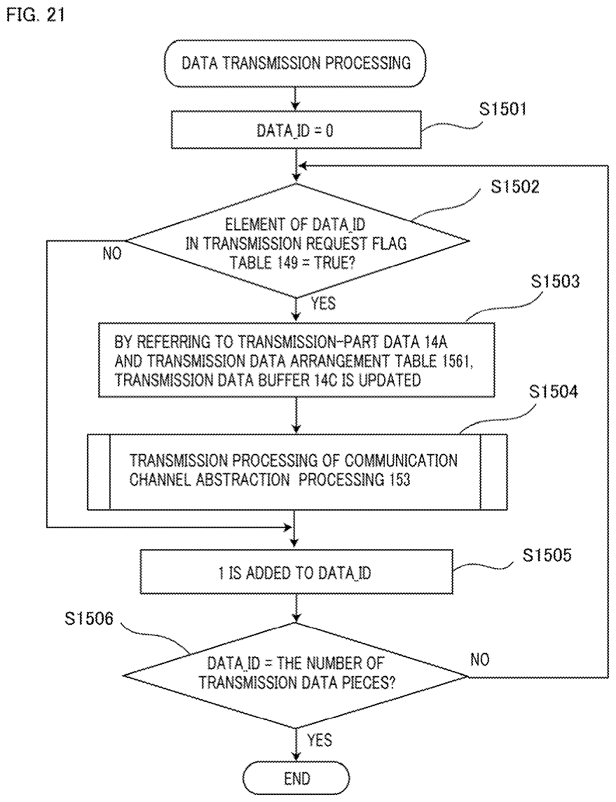

FIG. 21 is a flowchart exemplarily representing a procedure of data transmission processing of the control processing in the electronic control system according to Embodiment 1. In FIG. 21, in the step S1501, an automatic variable DATA_ID is initialized to “0”, and it is determined in the step S1502 whether or not the element of the automatic variable DATA_ID in the transmission request flag table 149 is “TRUE”; in the case where the element of the automatic variable DATA_ID is “TRUE” (YES), i.e., in the case where transmission is requested, the step S1502 is followed by the step S1503. In the step S1503, by referring to the transmission part data 14A and the element of the automatic variable DATA_ID in the transmission data arrangement table 1561, the contents stored in the transmission part data 14A corresponding to the automatic variable DATA_ID is written in the transmission data buffer 14C of the automatic variable DATA_ID, so that the transmission data buffer 14C is updated.

Next, in the step S1504, after the automatic variable DATA_ID and the contents of the transmission data buffer 14C, as parameters, are transferred to the transmission processing of the channel abstraction processing 153 so that the transmission processing of the channel abstraction processing 153 is called, or in the case where it is determined in the step S1502 that the element of the automatic variable DATA_ID in the transmission request flag table 149 is not “TRUE” but “FALSE” (NO), i.e., in the case where transmission is not requested, “1” is added to the automatic variable DATA_ID in the step S1505; then, the step S1505 is followed by the step S1506. In the step S1506, it is determined whether or not the automatic variable DATA_ID is the same as the total number of transmission data pieces; in the case where the automatic variable DATA_ID is smaller than the total number of transmission data pieces (NO), the step S1502 is resumed at the next automatic variable DATA_ID; in the case where the automatic variable DATA_ID is the same as the total number of transmission data pieces (YES), the processing is ended.

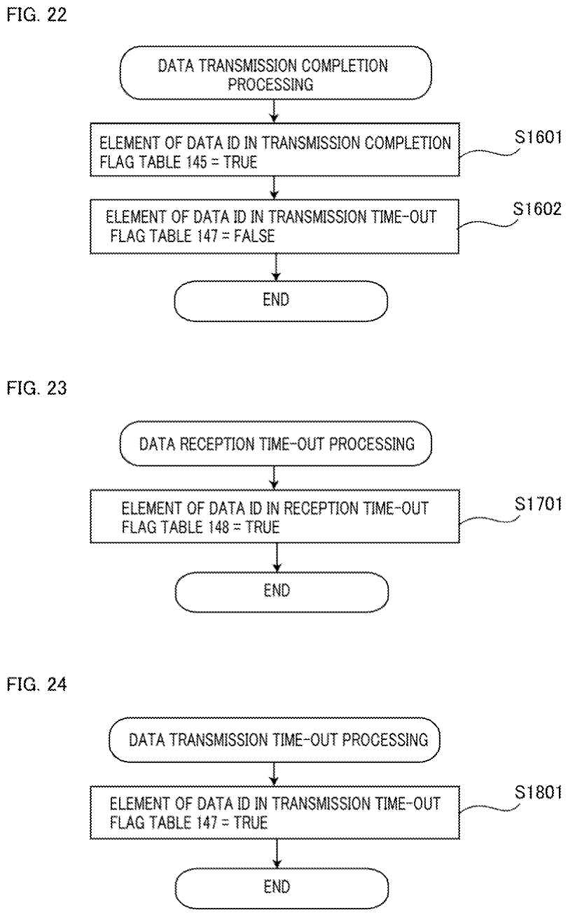

FIG. 22 is a flowchart exemplarily representing a procedure of data transmission completion processing of the control processing in the electronic control system according to Embodiment 1; the data transmission completion processing receives a data ID, as a parameter, from the step S904 for the transmission completion processing of the channel abstraction processing 153 so as to be called. In the data transmission completion processing of the control processing 155 represented in FIG. 22, the element of the data ID in the transmission completion flag table 145 is set to “TRUE” in the step S1601; next, in the step S1602, the element of the data ID in the transmission time-out flag table 147 is set to “FALSE”; then, the processing is ended.

FIG. 23 is a flowchart exemplarily representing a procedure of data reception time-out processing in the control processing in the electronic control system according to Embodiment 1. The data ID, as a parameter, is transferred from the step S1112 for the frame reception monitoring processing of the channel abstraction processing 153 to the data reception time-out processing of the control processing 155, so that the data reception time-out processing is called. In the step S1701, the element of the data ID in the reception time-out flag table 148 is set to “TRUE”; then, the processing is ended. It may be allowed that processing that needs to be instantaneously dealt with for the occurrence of a data reception time-out of a specific data ID is performed in this processing.

FIG. 24 is a flowchart exemplarily representing a procedure of data transmission time-out processing of the control processing in the electronic control system according to Embodiment 1; the data transmission time-out processing receives a data ID, as a parameter, from the step S1212 for the frame transmission monitoring processing of the channel abstraction processing 153 so as to be called. In the data transmission time-out processing of the control processing 155 represented in FIG. 24, the element of the data ID in the transmission time-out flag table 147 is set to “TRUE” in the step S1801; then, the processing is ended. It may be allowed that processing that needs to be instantaneously dealt with for the occurrence of a data transmission time-out of a specific data ID is performed in this processing.

FIG. 25 is a flowchart exemplarily representing a procedure of periodic processing of the control processing in the electronic control system according to Embodiment 1; the periodic processing, of the control processing 155, that is periodically called by use of a scheduler of an OS, the timer 18, or the like is represented. The calling period is determined in such a way as to be neither too long nor too short for a response time required for the control processing 155. Each time it is called, the periodic processing of the control processing 155 transfers the contents of the reception data buffer 14D to the reception-part data 14B, for each data ID with which reception has newly occurred; control-related processing is executed based on the updated reception-part data 14B; there is updated the transmission data buffer 14C of the data ID corresponding to the transmission-part data 14A updated by the execution of the control-related processing; then, the data transmission processing is called.

Describing more in detail, in FIG. 25, the automatic variable DATA_ID is initialized to “0” in the step S1901, and it is determined in the step S1902 whether or not the element of the DATA_ID in the reception time-out flag table 148 is “TRUE”. In the case where the element of the DATA_ID in the reception time-out flag table 148 is “TRUE” (YES), i.e., in the case where a reception time-out has occurred, the contents of the reception data buffer 14D of the DATA_ID is not transferred to the reception-part data 14B; instead, in the step S1905, “1” is added to the DATA_ID.

In contrast, it is determined in the step S1902 that the element of the DATA_ID in the reception time-out flag table 148 is not “TRUE” but “FALSE” (NO), i.e., in the case where no reception time-out has been detected, the step S1902 is followed by the step S1903, where it is ascertained whether or not the element of the DATA_ID in the reception notification flag table 146 is “TRUE”; in the case where it is determined in the step S1903 that the element of the DATA_ID in the reception notification flag table 146 is “TRUE” (YES), i.e., in the case where no new data has been received, the step S1903 is followed by the step S1904, where by referring to the reception data arrangement table 1563, the contents of the reception data buffer 14D of the DATA_ID is transferred to the reception-part data 14B.

After in the step S1904, the contents of the reception data buffer 14D is transferred to the reception-part data 14B or in the case where it is determined in the step S1903 that the element of the DATA_ID in the reception notification flag table 146 is not “TRUE” but “FALSE” (NO), i.e., in the case where no new data has been received, “1” is added to the DATA_ID in the step S1905. Next, in the step S1906, it is determined whether or not the DATA_ID is the same as the total number of reception data pieces; in the case where the DATA_ID is smaller than the total number of reception data pieces (NO), the step S1902 is resumed at the next DATA_ID. In the case where it is determined in the step S1906 that the DATA_ID has reached the total number of reception data pieces (YES), the step S1906 is followed by the step S1907, where control-related processing is executed; then, after data transfer processing is executed in the step S1908, the processing is ended.

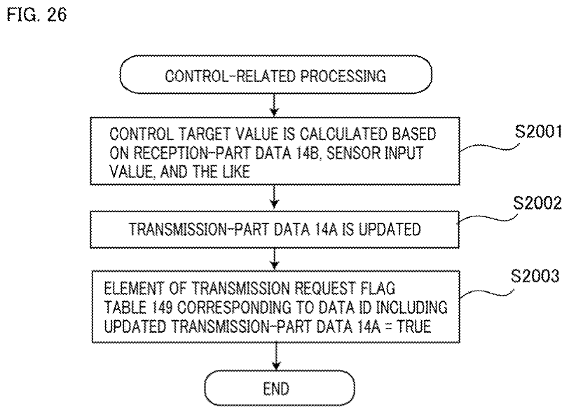

FIG. 26 is a flowchart exemplarily representing a procedure of control-related processing of the control processing in the electronic control system according to Embodiment 1; the control-related processing is called by the step S1907 for the foregoing periodic processing of the control processing 155. In the control-related processing, represented in FIG. 26, of the control processing 155, in the step S2001, a control target value is calculated based on the reception-part data 14B updated through the periodic processing, a separately read sensor input value, and the like; in the step S2002, the transmission-part data 14A is updated, as may be necessary. Next, in the step S2003, in order to transmit the updated contents, the element of the transmission request flag table 149 corresponding to the data ID including the updated transmission-part data 14A is set to “TRUE”; then, the processing is ended.

In each of FIGS. 2 through 26, the foregoing explanation has been limited to the communication functions; however, also in the case where functions other than the communication are dealt with, for example, also in the case where a sensor voltage or a value of a digital IC is read from the IC 16, the configuration can be made of separate processing items, i.e., hardware abstraction processing, channel abstraction processing (that is to say, that of an A/D converter to be connected with sensor devices and input pins of the digital IC), and control processing, as is the case with the respective reception processing items in FIGS. 2 through 26.

The foregoing electronic control system according to Embodiment 1 is provided with at least one CPU for executing a control program including at least one processing hierarchy, a secondary storage device for storing the control program, and a RAM configured in such a way as to be capable of storing and reading data for the control program; there has been materialized an electronic control system configured in such a way that when the behavior of the electronic control system is tested by communicating with a testing apparatus that creates requesting data for communication corresponding to processing in a testing program to be executed while changing the transmission direction of the communication to the reception direction thereof and changing the reception direction of the communication to the transmission direction thereof, the requesting data for the communication corresponding to processing in the control program to be executed is created without being changed between the transmission direction and the reception direction of the communication.

Next, the testing apparatus 4 represented in FIG. 1 will be explained. In FIG. 1, a terminal 5, as a main input/output terminal, is connected with an IO 41; the testing apparatus 4 includes a CPU 42, a RAM 43, a secondary storage device 44, a timer 45, and a communication IF 46. The testing apparatus 4 is communicatively connected with the ECU 1 through the communication IF 46 and the communication line 3.

The testing apparatus 4 operates as a control unit that executes a testing program. It may be allowed that testing apparatus 4 is a MICON, an SoC (System on a Chip), a PC (Personal Computer), or the like, as long as the respective functions of the foregoing constituent elements of the testing apparatus 4 are provided.

The CPU 42 is included in a control unit for controlling the respective units provided in the testing apparatus 4. The CPU 42 can execute an after-mentioned testing program 440 to be stored in the secondary storage device 44. When an interruption occurs during the execution of the testing program 440, the CPU 42 can execute processing corresponding to the interruption. The CPU 42 may be formed of two or more CPUs, as long as the IC 41, the RAM 43, the secondary storage device 44, the timer 45, and the communication IF 46 can be accessed. The RAM 43 is a storage unit that can be accessed by the CPU 42 and stores data in a rewritable manner.

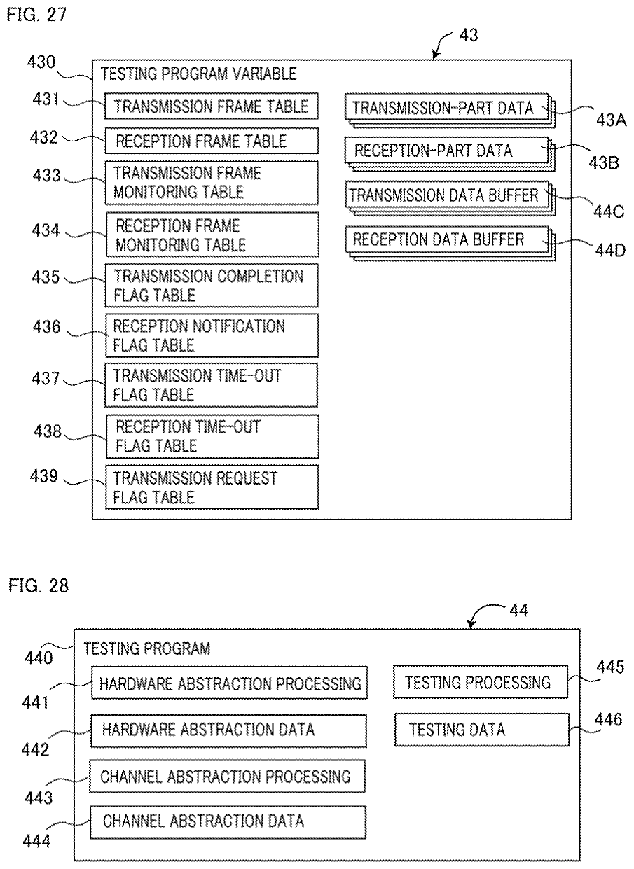

FIG. 27 is an explanatory diagram representing respective contents of variables, to be accessed by a communication part of the control program, in the electronic control system according to Embodiment 1; the contents of variables for the communication part of the after-mentioned testing program 440 to be stored and updated in the RAM 43 in Embodiment 1 are exemplarily represented. The respective variable types of the testing program variables 430 are the same as those of the control program variables 140 in FIG. 2; thus, the detailed explanation therefor will be omitted.

Because it is required that the testing apparatus 4 receives a communication frame to be transmitted by the ECU 1 and transmits a communication frame to be received by the ECU 1, the transmission frame table 141, the transmission frame monitoring table 143, the transmission completion flag table 145, the transmission time-out flag table 147, the transmission request flag table 149, the transmission-part data 14A, and the transmission data buffer 14C that are related to transmission of the control program variables 140 correspond to a reception frame table 432, a reception frame monitoring table 434, a reception notification flag table 436, a reception time-out flag table 438, a reception-part data 43B, and a reception data buffer 43D, respectively, that are related to reception of the testing program variables 430 of the testing apparatus 4.

The transmission frame table 431, the transmission frame monitoring table 433, the transmission completion flag table 435, the transmission time-out flag table 437, the transmission request flag table 439, a transmission-part data 43A, and a transmission data buffer 43C that are related to transmission of the testing program variables 430 correspond to the reception frame table 142, the reception frame monitoring table 144, the reception notification flag table 146, the reception time-out flag table 148, the reception-part data 14B, and the reception data buffer 14D, respectively, that are related to reception of the testing program variables 140 of the ECU 1 in FIG. 2.

In general, the secondary storage device 44 in FIG. 1 is a storage unit that stores data in a state where only readout is possible. In this regard, however, the secondary storage device 44 may be a storage device, such as an EPROM, a NOR-type flash memory, or a NAND-type flash memory, that can rewrite data according to a specific method. In the case where the CPU 42 cannot directly execute the testing program 440 stored in the secondary storage device 44 by use of a NAND-type flash memory or the like, it may be allowed that the contents of the testing program 440 is transferred from the secondary storage device 44 to the RAM 43 and then the control program 440 is executed on the RAM 43.

FIG. 28 is an explanatory diagram exemplarily representing the contents of the communication part of the testing program in the electronic control system according to Embodiment 1. In FIG. 28, hardware abstraction processing 441, hardware abstraction data 442, channel abstraction processing 443, channel abstraction data 444, and testing data 446 in the testing program 440 to be stored in the secondary storage device 44 are the same as the respective processing items or data types of the hardware abstraction processing 151, the hardware abstraction data 152, the channel abstraction processing 153, the channel abstraction data 154, and the control data 156 in the control program 150 in FIG. 3; thus, the detailed explanation therefor will be omitted. Among the contents of the testing processing 445 in FIG. 28, the parts thereof that are different from the contents of the control processing 155 and the control data 156 in FIG. 3 will be explained in detail later. Because it is required that the testing apparatus 4 receives a communication frame to be transmitted by the ECU 1 and transmits a communication frame to be received by the ECU 1, the hardware abstraction data 442, the channel abstraction data 444, and the testing data 446 are created in such a way that the respective transmissions and receptions of the hardware abstraction data 152, the channel abstraction data 154, and the control data 156 of the electronic control system 1 are mutually reversed.

Its behavior of measuring elapsed time is started or stopped by the CPU 42, so that the timer 45 notifies the CPU 42 of the elapsed time. A dedicated register provided in the timer 45 is read by the CPU 42, so that the elapsed time measured by the timer 45 can be obtained; when a preliminarily set time has elapsed, the timer 45 can notify the CPU 13 in an interrupting manner that the preliminarily set time has elapsed. The communication IF 46 is utilized when communication with other ECUs is performed; in Embodiment 1, communication IF 46 is utilized for performing communication with the ECU 1. Accordingly, the communication is performed according to a specification the same as that of the ECU 1.

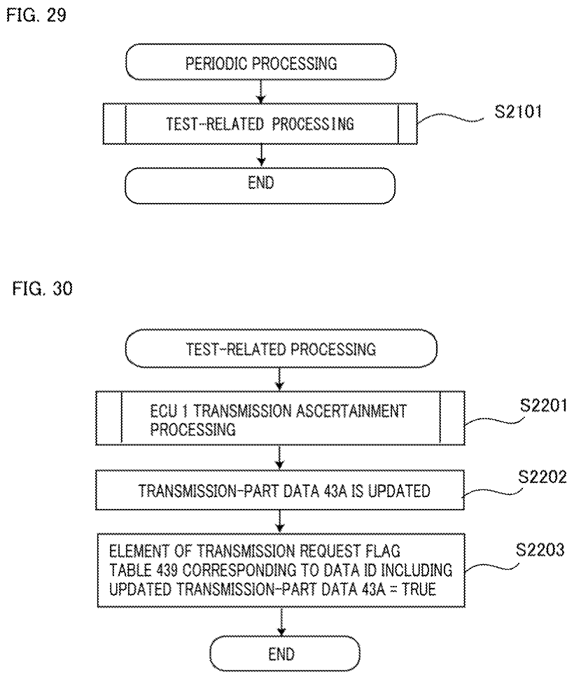

FIG. 29 is a flowchart exemplarily representing a procedure of periodic processing of the testing processing in the testing apparatus according to Embodiment 1; the periodic processing is periodically called by use of a scheduler of an OS, the timer 45, or the like. The calling period is determined in such a way as to be neither too long nor too short for a response time required for the testing processing 445. As represented in FIG. 29, in the step S210, each time the periodic processing of the testing processing 445 is called, the testing processing 445 is called.

FIG. 30 is a flowchart exemplarily representing a procedure of test-related processing in the testing processing in the testing apparatus according to Embodiment 1; the test-related processing is periodically called by the step S2101 for the periodic processing of the testing processing 445. In FIG. 30, in Embodiment 1, in the test-related processing of the testing processing 445, transmission ascertainment processing of the ECU 1 is called in the step S2201 so that transmission from the ECU 1 is ascertained. Next, in the step S2202, data value to be transmitted to the ECU 1 is written in the transmission-part data 43A so as to update the transmission-part data 43A; in the step S2203, the element of the transmission request flag table 439 corresponding to the data ID including the updated transmission-part data 43A is set to “TRUE”; then, the processing is ended. The transmission data value from the ECU 1 for the data to be transmitted in this situation is ascertained in ECU 1-transmission ascertainment processing to be called in and after the next period.

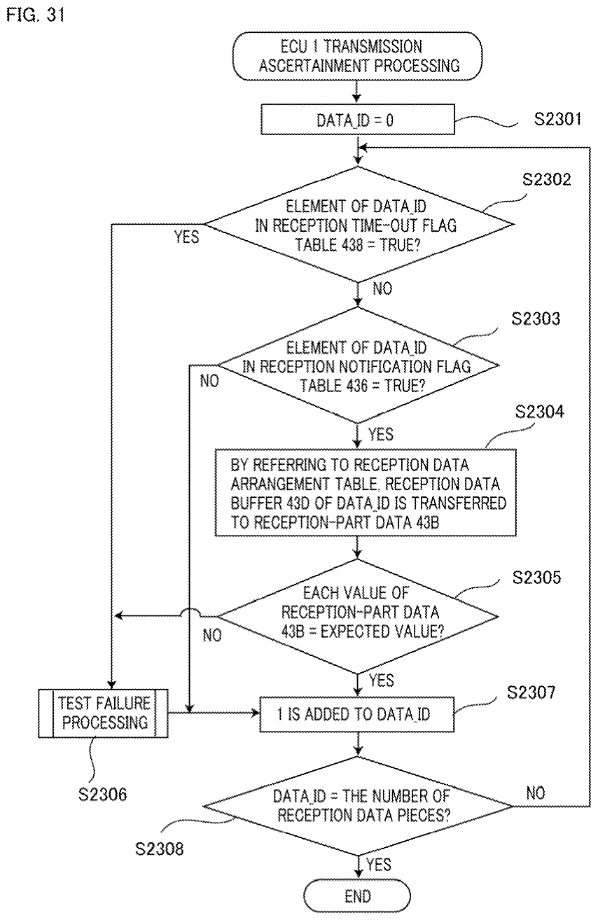

FIG. 31 is a flowchart exemplarily representing a procedure of ECU transmission ascertainment processing in the testing processing in the testing apparatus according to Embodiment 1; the ECU 1-transmission ascertainment processing is periodically called by the step S2101 for the test-related processing of the testing processing 445. In the ECU 1-transmission ascertainment processing in the testing processing 445 represented in FIG. 31, in order to ascertain data to be transmitted from the ECU 1, data to be received by the testing processing 445 is ascertained for each data ID. In Embodiment 1, as an example of the ascertainment, the automatic variable DATA_ID is set to “0” in the step S2301, and it is determine in the step S2302 whether or not the element of the DATA_ID in the reception time-out flag table 438 is “TRUE”.

In the case where it is determined in the step S2302 that the element of the DATA_ID in the reception time-out flag table 438 is “TRUE” (YES), it is determined that the foregoing data has not been received within an expected time; then, the step S2302 is followed by the step S2306, where test failure processing is called. In contrast, it is determined in the step S2302 that the element of the DATA_ID in the reception time-out flag table 438 is not “TRUE” but “FALSE” (NO), the step S2302 is followed by the step S2303, where it is ascertained whether or not the element of the DATA_ID in the reception notification flag table 436 is “TRUE”.

In the case where it is determined in the step S2303 that the element of the DATA_ID in the reception notification flag table 436 is “TRUE” (YES), it is determined that the foregoing data has been received within the expected time; then, the step S2303 is followed by the step S2304, where by referring to the reception data arrangement table, the contents of the reception data buffer 43D of the DATA_ID is transferred to the reception-part data 43B, and the step S2304 is followed by the step S2305. In contrast, in the case where it is determined in the step S2303 that the element of the DATA_ID in the reception notification flag table 436 is not “TRUE” but “FALSE” (NO), the step S2303 is followed by the step S2307.

In the step S2305, each of the values of the reception-part data pieces 43B is compared with a corresponding expected value; in the case where each of the values of the reception-part data pieces 43B does not coincide with the corresponding expected value (NO), the step S2305 is followed by the step S2306, where the test failure processing is called; then, the step S2306 is followed by the step S2307. As the reception data arrangement table for the testing apparatus 4, an reception data arrangement table the same as the reception data arrangement table 1563, in FIG. 18, for the ECU 1 is utilized. When the step S2303 or the step S2306 is followed by the step S2307, “1” is added to the DATA_ID; then, the step S2307 is followed by the step S2308. That is to say, in the case where the element of the DATA_ID in the reception notification flag table 436 is “FALSE” or in the case where each of the values of the reception-part data pieces 43B coincides with the corresponding expected value, the next DATA_ID is ascertained, when the DATA_ID is smaller than the total number of reception data pieces; then, the step S2307 is followed by the step S2308.

In the step S2308, it is determined whether or not the DATA_ID has reached the total number of reception data pieces; in the case where the DATA_ID has not reached the total number of reception data pieces (NO), the step S2302 is resumed; in the case where the DATA_ID has reached the total number of transmission data pieces (YES), the processing is ended.

The ECU 1-transmission ascertainment processing is not limited to the foregoing one; for example, when it is expected that data to be transmitted from the ECU 1 is periodically transmitted, the period can also be ascertained. In contrast, in the case where it is ascertained whether or not the ECU 1 correctly receives data transmitted by the testing processing 445, it may be allowed that testing transmission/reception frames and testing data IDs are additionally defined for the ECU 1 and the testing apparatus 4 and that it is ascertained whether or not data received by the ECU 1 is returned with the testing data ID and the testing apparatus 4 receives the data with the testing data ID.

It may be allowed that in order to ascertain whether or not the data received by the ECU 1 is reflected in each of the reception-part data pieces 14B, there is preliminarily established a known communication protocol, such as XCP (Universal Calibration Protocol), that makes it possible that the testing apparatus 4 can read each of the values of the reception-part data pieces 14B of the ECU 1 by designating the address, and that each of the values of the reception-part data pieces 14B of the ECU 1 is read through XCP communication so that the ascertainment is performed.

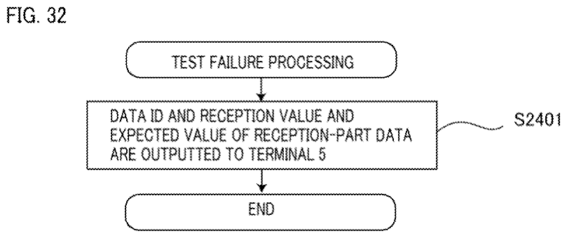

FIG. 32 is a flowchart exemplarily representing a procedure of test failure processing in the testing processing in the testing apparatus according to Embodiment 1; in Embodiment 1, in the case where in the ECU 1-transmission ascertainment processing in the testing processing 445 represented in foregoing FIG. 31, no data is received within an expected time or in the case where data received from the ECU 1 does not coincide with an expected value, the test failure processing is called. In the test failure processing of the testing processing 445 represented in FIG. 32, in the case where it is detected that the data ID, which has caused the processing to be called and the reception-part data 43B do not coincide with each other, the reception value and the expected value are outputted to the terminal 5 in the step S2401; then, the processing is ended.

The foregoing testing apparatus for the electronic control system according to Embodiment 1 is provided with

at least one CPU that executes a testing program including at least one processing hierarchy,

a secondary storage device that stores the testing program, and

a RAM configured in such a way as to be capable of storing and reading data for the testing program; there has been materialized a testing apparatus configured in such a way that when the behavior of an electronic control system is tested by communicating with the electronic control system that creates requesting data for communication corresponding to processing in a control program to be executed, without making any change between the transmission direction of the communication and the reception direction thereof, the requesting data for the communication corresponding to processing in the testing program to be executed is created while changing the transmission direction of the communication to the reception direction thereof and changing the reception direction of the communication to the transmission direction thereof.

The electronic control system and the electronic-control-system testing apparatus according to Embodiment 1 are utilized for testing the electronic control system according to Embodiment 1. That is to say, the electronic-control-system testing method according to Embodiment 1 is the one in which the behavior of the electronic control system is tested based on communication between the electronic control system and the testing apparatus; the electronic control system is provided with

at least one CPU that executes a control program including at least one processing hierarchy,

a secondary storage device that stores the control program, and

a RAM configured in such a way as to be capable of storing and reading data for the control program; the testing apparatus is provided with

at least one CPU that executes a testing program including at least one processing hierarchy,

a secondary storage device that stores the testing program, and

a RAM configured in such a way as to be capable of storing and reading data for the testing program; there has been materialized an electronic-control-system testing method in which requesting data for the communication corresponding to processing in a control program to be executed is created, without making any change therein between the transmission direction of the communication and the reception direction thereof, and in which requesting data for the communication corresponding to processing in the testing program to be executed is created while changing the transmission direction of the communication to the reception direction thereof and changing the reception direction of the communication to the transmission direction thereof.

As described above, in the electronic control system and the testing apparatus according to Embodiment 1, the respective processing items and types of the control program 150 for the ECU 1 and the testing program 440 for the testing apparatus 4 are made to be the same as each other; the hardware abstraction data 152, the channel abstraction data 154, and the control data 156 of the ECU 1 are created according to the communication-request specification of the ECU 1; the hardware abstraction data 442, the channel abstraction data 444, and the testing data 446 of the testing apparatus 4 are created by interchanging the transmission with the reception of the communication-request specification of the ECU 1. As a result, the creation method for the hardware abstraction data 442, the channel abstraction data 444, and the testing data 446 of the testing apparatus 4 can be integrated with the creation method for the hardware abstraction data 152, the channel abstraction data 154, and the control data 156 of the ECU 1; therefore, the testing program 440 for the testing apparatus 4 can be created by such a minimally necessary change as to interchange the transmission of the communication-request specification of the ECU 1 with the reception thereof, and a function (e.g., the reception time-out detection function) of the channel abstraction processing 443 of the testing apparatus 4 can be utilized in determining the test.

As far as the control program 150 of the ECU 1 and the testing program 440 of the testing apparatus 4 are concerned, reduction of the creation man-hours can more be expected as the respective implementation types of the processing items and the respective types of data pieces are more close to each other; in particular, when the ECU 1 and the testing apparatus 4 are each formed of the same hardware, and the control program 150 and the testing program 440 for the testing apparatus 4 each have one and the same language and implementation, it can be expected that the reduction amount of the creation man-hours becomes maximum. However, because the present disclosure does not depend on implementation with specific hardware and a specific programming language, it may be allowed that the programming language for implementing the respective processing items of the testing program 440 is different form the programming language for implementing the respective processing items of the control program 150 of the ECU 1.

In Embodiment 1 of the present disclosure, each of the control program 150 of the ECU 1 and the testing program 440 is divided into three processing hierarchies; however, the division degree of the processing hierarchy is not limited thereto. For example, it may be allowed that each of the control processing 155 of the ECU 1 and the testing processing 445 of the testing apparatus 4 is further divided so that there are provided the respective processing hierarchies for executing the transmission-data creation processing (the step S1501) to be performed in the data transmission processing and the reception-data division processing (the step S1401) to be performed in the data reception processing.

Moreover, in Embodiment 1 of the present disclosure, the hardware abstraction data 152, the channel abstraction data 154, and the control data 156 are stored in the secondary storage device 15, and the hardware abstraction data 442, the channel abstraction data 444, and the testing data 446 are stored in the secondary storage device 44; however, each of the configurations is not limited thereto. For example, it may be allowed that in the case where the transmission frame data length 1542A, the reception frame monitoring deadline 1543D, and the like are determined by a communicating external ECU and are required to be changed during the communication, the storage area for the transmission frame data length 1542A and the reception frame monitoring deadline 1543D is secured in the RAM 14 during the communication and the area in the RAM 14 is referred to during the communication. In this case, for example, it may be allowed that the initial values of the transmission frame data length 1542A and the reception frame monitoring deadline 1543D are stored, that in the initialization processing in FIG. 5, the values of the transmission frame data length 1542A and the reception frame monitoring deadline 1543D are transferred to the corresponding area of the RAM, and that when the external ECU gives notice of a change in the value, the area of the RAM is updated. The same method may be applied also to the testing apparatus.

In addition, it may be allowed that as each of the MICON 12 and the testing apparatus 4, an SoC, a PC, or the like is utilized and as the process of the OS, the control program 150 or the testing program 440 is executed. In that case, it may be allowed that when the OS starts the control program 150, the contents of the control program 150 is transferred from the secondary storage device 15 to the RAM 14 so that the control program 150 is executed on the RAM 14; alternatively, it may be allowed that when the OS starts the testing program 440, the contents of the testing program 440 is transferred from the secondary storage device 44 to the RAM 43 so that the control program 150 is executed on the RAM 14.

Furthermore, in Embodiment 1 of the present disclosure, there has been explained the case where the ECU 1 is connected only with the testing apparatus 4; however, the present disclosure is not limited thereto. For example, even when the testing apparatus 4 is connected with two or more ECUs resembling the ECU 1 through the communication line 3, the test can be performed in the same manner, by providing as many hardware abstraction data pieces 442 as the number of the two or more ECUs, as many channel abstraction data pieces 444 as the number of the two or more ECUs, and as many testing data pieces 446 as the number of the two or more ECUs, of the testing apparatus 4 and by utilizing the means explained in Embodiment 1 of the present disclosure.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, there are included the cases where at least one constituent element is modified, added, or omitted.

What is claimed is:

1. An electronic control system comprising:
at least one CPU that executes a control program including at least one processing hierarchy,
a secondary storage device that stores the control program, and
a RAM configured in such a way as to be capable of storing and reading data for the control program,
wherein when behavior of the electronic control system is tested by communicating with a testing apparatus that creates requesting data for communication corresponding to processing in a testing program to be executed, while changing a transmission direction of the communication to a reception direction thereof and changing the reception direction of the communication to the transmission direction thereof, requesting data for the communication corresponding to processing in the control program to be executed is created without being changed between the transmission direction and the reception direction of the communication.

2. The electronic control system according to claim 1, wherein the control program and the testing program each include the same processing hierarchy.

3. An electronic-control-system testing apparatus comprising:
at least one CPU that executes a testing program including at least one processing hierarchy,
a secondary storage device that stores the testing program, and
a RAM configured in such a way as to be capable of storing and reading data for the testing program,
wherein when behavior of an electronic control system is tested by communicating with the electronic control system that creates requesting data for communication corresponding to processing in a control program to be executed, without making any change between a transmission direction of the communication and a reception direction thereof, requesting data for the communication corresponding to processing in the testing program to be executed is created, while changing the transmission direction of the communication to the reception direction thereof and changing the reception direction of the communication to the transmission direction thereof.

4. The electronic-control-system testing apparatus according to claim 3, wherein the control program and the testing program each include the same processing hierarchy.

5. An electronic-control-system testing method in which behavior of an electronic control system is tested based on communication between the electronic control system and a testing apparatus,
wherein the electronic control system includes
at least one CPU that executes a control program including at least one processing hierarchy,
a secondary storage device that stores the control program, and
a RAM configured in such away as to be capable of storing and reading data for the control program,
wherein the testing apparatus includes
at least one CPU that executes a testing program including at least one processing hierarchy,
a secondary storage device that stores the testing program, and
a RAM configured in such away as to be capable of storing and reading data for the testing program,
wherein requesting data for the communication corresponding to processing in the control program to be executed is created without being changed between a transmission direction and a reception direction of the communication, and
wherein requesting data for the communication corresponding to processing in the testing program to be executed is created, while changing the transmission direction of the communication to the reception direction thereof and changing the reception direction of the communication to the transmission direction thereof.

6. The electronic-control-system testing method according to claim 5, wherein the control program and the testing program each include the same processing hierarchy.
